(19) United States
(12) Patent Application Publication
(10) Pub. No.: US 2024/0411146 A1
(43) Pub. Date: Dec. 12, 2024

(54) DEVICE FOR EMITTING A LIGHT BEAM AND PARTIAL BEAM SPLITTER

(71) Applicant: Innoviz Technologies Ltd., Rosh Ha'ayin (IL)

(72) Inventors: Ronen ESHEL, Herzliya (IL); Neriya FELDMUS, Elkana (IL); Yuval YIFAT, Tel Aviv-Yafo (IL); Amy ENTIN, Tel Aviv-Yafo (IL); Harel Yosef SHFARAM, Kibbutz Revadim (IL)

(21) Appl. No.: 18/810,859

(22) Filed: Aug. 21, 2024

Related U.S. Application Data
(63) Continuation of application No. PCT/IB2023/051540, filed on Feb. 20, 2023.
(60) Provisional application No. 63/312,138, filed on Feb. 21, 2022.
(60) Provisional application No. 63/370,695, filed on Aug. 8, 2022.

(51) Int. Cl. G02B 27/09; G01S 17/06; G02B 5/04; G02B 27/00

(52) U.S. Cl. CPC G02B 27/0927; G01S 17/06; G02B 5/045; G02B 27/0075; G02B 27/0972

(57) ABSTRACT

A device includes an optical path and a beam profile redistributor arranged in the optical path to receive an input light beam. The beam profile redistributor is configured to convert the received input light beam so that at least one output light beam of the device includes, (i) in a near field and/or at the beam profile redistributor, a redistributed beam intensity profile compared to at least one further output light beam when the beam profile redistributor is not present, (ii) within a given measuring aperture at a position along the optical path in the near field, a lower output light power compared to the at least one further output light beam, and (iii) in a far field, at least substantially the same beam intensity profile compared to the at least one further output light beam. Other embodiments are also described.

### CROSS-REFERENCE TO RELATED APPLICATIONS

The present application is a continuation of International Patent Application No. PCT/IB2023/051540, published as WO 2023/156982, which claims the benefit of U.S. Provisional Application No. 63/312,138, filed Feb. 21, 2022, whose disclosure is incorporated herein by reference, and U.S. Provisional application 63/370,695, filed Aug. 8, 2022, whose disclosure is incorporated herein by reference.

### FIELD OF EMBODIMENTS OF THE INVENTION

Embodiments of the present invention relate to devices for emitting a light beam, in particular a laser beam in an eye-safe manner, partial beam splitters that may be used in the devices.

### BACKGROUND

Many modern devices rely on lasers to implement desired functions. Well-known everyday examples include an optical mouse and a laser pointer using a collimated laser beam. More complex devices are used in the fields of optical analysis and detection. For example, a LIDAR device may be used to detect and/or measure properties of objects by illuminating the objects with a laser, e.g. an infrared laser, and measuring back reflected light with a sensor. LIDAR has found terrestrial, airborne, and mobile applications such as in driver assist systems and autonomous vehicles. This is because automobiles are desired to be equipped with systems capable of reliably sensing and interpreting their surroundings, including identifying obstacles, hazards, objects, and other physical parameters that might impact navigation of the vehicle.

A laser is one example of a light source that can be used in a LIDAR system. As with any sensing system, in order for a LIDAR-based sensing system to be fully adopted by the automotive industry, the system should provide reliable data enabling detection of distant objects. Thus, operating in maximum illumination power of LIDAR systems is preferred. Currently, however, the maximum illumination power of LIDAR systems is limited by the need to make the LIDAR systems eye-safe. For example, LIDAR systems are required to prevent damage to the human eye which can occur if a projected light emission enters the eye's cornea and lens, causing thermal damage to the retina.

In particular when operating with a focused or collimated laser beam, such devices are potentially hazardous to (human unaided) eyes (or even the skin). To prevent damage, such (laser-based) devices are classified accordingly by their potential hazard level, and must fulfill respective safety requirements.

For example, according to standard EN 60825-1:2007, a maximum-allowed power, or acceptable emission limit (AEL) level is defined. For a 900 nm wavelength Class 1 laser, the AEL is 1 mW when measuring flux through a 7 mm aperture outside the device (14 mm from the point where the laser beam exits the device).

Expanding the emitted (transmitted) illumination beams) may reduce the flux by increasing the spot size and spreading the beam energy is over a larger area. However, expanding the emitted (transmitted) beam and enlarging the devices transmission aperture, respectively, is not always a viable solution to ensure eye-safety. Other optical elements of the device, such as a scanner in the light path, may benefit from a smaller beam spot size. The size of these optical elements may need to scale with the size of the beam spot. This may impact size and/or cost constraints. For example, a LIDAR device may include a rotating polygon scanner to deflect laser beams towards a FOV. Light emitted towards the edge of the polygon facet during rotation may be partially incident on the edge of the polygon facet for a longer time, depending on the beam spot size. Thus, increasing the laser beam spot size would require increasing the size of the rotating polygon scanner to ensure the same functionality/performance.

For these and other reasons there is a need for the present invention.

### SUMMARY

At least the above-mentioned issues are addressed by the subject matter of the appended claims.

In one aspect, a device includes an optical path and a beam profile redistributor arranged in the optical path to receive an input light beam. The beam profile redistributor is arranged in the optical path to receive an input light beam and configured to convert the received input light beam so that at least one output light beam of the device includes, in a near field and/or at the beam profile redistributor, a redistributed beam intensity profile compared to at least one further output light beam when the beam profile redistributor is not present and/or replaced by at least one mirror; within a given measuring aperture at a position along the optical path in the near field, a lower (typically a lower maximum) output light power compared to the at least one further output light beam; and in a far field, at least substantially the same beam intensity profile compared to the at least one further output light beam.

The device explained herein may be used for emitting the at least one output light beam through a device aperture and to receive, through the device aperture back-reflected light beam(s). Compared to known similar devices, the device explained herein allow for a better trade-off between an effective emission area and a receiving efficiency. Accordingly, eye safety may be ensured at high detection sensitivity in a comparatively simple and/or cost efficient way.

In a further aspect, a LIDAR device includes an optical path, and a beam profile redistributor arranged in the optical path for receiving an input light beam and configured to convert the received input light beam into at least one output light beam. In a cross-section, which is at least substantially parallel to the optical path (at least at and/or in the beam profile redistributor), in particular in a respective cross-section including the optical path (or even in several respective cross-sections), the beam profile redistributor includes a first pair of adjacent refractive surfaces, and a second pair of adjacent refractive surfaces. The first pair of adjacent refractive surfaces is arranged between the input light beam and the second pair of adjacent refractive surfaces. The second pair of adjacent refractive surfaces is arranged between the first pair of adjacent refractive surfaces and the at least one output light beam.

In a yet further aspect, a one-piece partial beam splitter for splitting an incident light beam into two light beams includes a first transmittance for a first transverse wave of the incident light beam, the first transverse wave comprising a first wavelength and a first polarization, and a second transmittance for a second transverse wave of the incident light beam, the second transmittance being larger than zero and lower than the first transmittance, the second transverse wave including a second wavelength at least substantially matching the first wavelength, and a second polarization different to the first polarization.

Those skilled in the art will recognize additional features and advantages upon reading the following detailed description, and upon viewing the accompanying drawings.

### BRIEF DESCRIPTION OF THE DRAWINGS

The components in the figures are not necessarily to scale, instead emphasis being placed upon illustrating the principles of the invention. Moreover, in the figures, like reference numerals designate corresponding parts. In the drawings:

FIGS. 1, 2 are diagrams schematically illustrating devices according to embodiments;

FIGS. 3A to 3F illustrate beam intensity profiles of light beams that may be generated using the devices illustrated in FIGS. 1, 2;

FIG. 4 is a diagram schematically illustrating a device according to an embodiment;

FIG. 5 is a diagram schematically illustrating a device according to an embodiment;

FIGS. 6A to 6C illustrate beam intensity profiles of light beams that may be generated using the device illustrated in FIG. 5;

FIG. 7 is a diagram schematically illustrating a device according to an embodiment;

FIG. 8 is a diagram schematically illustrating a device according to an embodiment;

FIG. 9 is a diagram schematically illustrating a device according to an embodiment;

FIG. 10 is a diagram schematically illustrating a device according to an embodiment;

FIGS. 11A-11B are diagrams schematically illustrating a device according to embodiments;

FIG. 12 is a diagram schematically illustrating a device according to an embodiment;

FIG. 13 is a diagram schematically illustrating an optical device;

FIG. 14 is a diagram schematically illustrating a device including a one-piece partial beam splitter according to an embodiment;

FIG. 15 is a diagram schematically illustrating a device including a one-piece partial beam splitter according to an embodiment;

FIG. 16 to FIG. 20 schematically illustrate respective one-piece partial beam splitters according to embodiments;

FIG. 21 is a diagram schematically illustrating a device including two one-piece partial beam splitters according to an embodiment;

FIG. 22 is a diagram schematically illustrating a device including a one-piece beam profile redistributor with integrated partial beam splitter according to an embodiment;

FIG. 23A and FIG. 23B schematically illustrate respective one-piece beam profile redistributors with integrated partial beam splitter according to embodiments;

FIG. 24 is a diagram schematically illustrating a device including a one-piece partial beam splitter according to an embodiment;

FIGS. 25A to 25F illustrate beam intensity profiles of light beams that may be generated using the device illustrated in FIG. 14 or 15.

For sake of clarity, the Figures are provided with a respective Cartesian co-ordinate system x, y, z typically representing a respective device coordinate system.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Reference will now be made in detail to various embodiments, one or more examples of which are illustrated in the figures. Each example is provided by way of explanation, and is not meant as a limitation of the invention. For example, features illustrated or described as part of one embodiment can be used on or in conjunction with other embodiments to yield yet a further embodiment. It is intended that the present invention includes such modifications and variations.

### General

In one embodiment, a device includes an optical path and a beam profile redistributor arranged in the optical path to receive an input light beam. The beam profile redistributor is arranged in the optical path to receive an input light beam and configured to convert the received input light beam so that at least one output light beam of the device includes, in a near field and/or at the beam profile redistributor, e.g. downstream from the beam profile redistributor and along the optical path (and in the near field), a redistributed beam intensity profile compared to at least one further output light beam when the beam profile redistributor is not present and/or replaced by at least one mirror; within a given measuring aperture at a position along the optical path in the near field, a lower (typically a lower maximum) output light power compared to the at least one further output light beam; and in a far field, at least substantially the same beam intensity profile compared to the at least one further output light beam.

While the output light beam(s) of the device typically refers to an emitted light beam of the device during normal device operation, the further output light beam(s) is (arc) not emitted during normal device operation. Instead, the further output light beam(s) may correspond to a (respective) emitted light beam of the device without the beam profile redistributor (when the beam profile redistributor is removed from the optical path and the device, respectively, replaced by one or more mirrors), or another (otherwise identical comparison) device without the beam profile redistributor during a comparison measurement, or even to a respective calculated light beam that may be emitted by the device assuming that the beam profile redistributor is not present. Accordingly, the further output light beam(s) is (arc), in the following, also referred to as virtual output light beam(s) (of the device) and undesired output light beam(s) (of the device), respectively.

The device explained herein may be used for emitting the at least one output light beam through a device aperture, which is typically different to a measuring aperture as required by a safety standard, and is in the following also referred to as aperture for short, and to receive, through the (device) aperture back-reflected light beam(s), and at a light detector of the device such as a photodiode.

Compared to known similar devices, the device explained herein allow for, increasing a receiving efficiency (receiving part of the optical path), which may be defined as a ratio between an effective (light sensitive) area of the light detector illuminated by a back-reflected light beam and an area of the back-reflected light beam at the device aperture, at the same effective area (from eye safety perspective) over which the emission energy of the at least one output light beam is spread (in the following also referred to as effective emission area for short), and/or increasing, at the same receiving efficiency, the effective area over which the emission energy of the at least one output light beam is spread, for example doubling the effective emission area.

In other words, a better trade-off between the effective emission area and the receiving efficiency may be achieved with the devices explained herein.

Accordingly, eye safety may be ensured at high detection sensitivity in a comparatively simple and/or cost efficient way. For example, it is also possible to dispense with reducing the light beam power for safety reasons at times when people are expected or even detected within the field of view of the device, e.g. a LIDAR of a car.

Note that the above defined receiving efficiency substantially corresponds to portions of the receive aperture blocked by elements included in the system by design, and not the impact of losses due to quality of the optical surfaces (e.g. coatings). Such losses are minor percentage losses due to back-reflected light in the device. These losses amount to at most, a few percent larger or even only at most 1 percent larger than the corresponding power ratio between a power of the back-reflected light beam(s) received at the light detector and a power of the back-reflected light beam(s) at the device aperture.

The input light beam may originate from (only) one light source, several light sources or even a plurality of light sources.

For example, light beams emitted by typically substantially equal light sources may be projected, typically focused onto the beam profile redistributor, more particular onto substantially the same area of the beam profile redistributor. The thereby formed input light beam thus includes partial input light beam entering the beam profile redistributor at (substantially) the same area.

In one embodiment, the at least one output light beam includes, in the near field and in a bounding box for the (at least one) output light beam at least substantially the same boundary compared to the (at least one) further output light beam.

In this embodiment, the beam profile redistributor is typically arranged in the optical path to receive the input light beam and configured to convert the received input light beam so that at least one output light beam of the device includes, in near field and in a bounding box for the at least one output light beam along the optical path, a redistributed beam intensity profile compared to at least one further output light beam when the beam profile redistributor is not present and/or replaced by at least one mirror; within a given measuring aperture at a position along the optical path in the near field, a lower (typically a lower maximum) output light power compared to the at least one further output light beam; and in a far field, at least substantially the same beam intensity profile compared to the at least one further output light beam.

The optical path may be folded and/or includes a transmitting part typically at least extending from the beam profile redistributor (and/or one or more one-piece partial beam splitter as explained herein that may be part of or even form the beam profile redistributor for enlarging the effective emission area) at least to the device aperture, and a receiving part typically extending from the device aperture through (typically a part of) the beam profile redistributor (and/or the one-piece partial beam splitter(s)) to the light detector.

In these embodiments, the receiving efficiency of the device is typically larger compared to known similar devices, in particular larger than 1 minus an effective emission area of the (at least one) output light beam at the device aperture divided by two times the area of the back-reflected light beam at the aperture, in particular at least 1 minus the effective emission area divided by 4 times the area of the back-reflected light beam at the aperture or even least 1 minus the effective emission area divided by six times the area of the back-reflected light beam at the aperture.

The transmitting part and the receiving part may at least substantially coincide between the device aperture and the beam profile redistributor (and/or the one-piece partial beam splitter(s)), except for a light beam direction.

The light source is typically arranged in the transmitting part of the optical path for emitting the incident light beam, in particular an incident light beam of a defined (e.g. linear, elliptic or circular) polarization.

Typically, the reflectance of the one-piece partial beam splitter is about one (100%) for the defined polarization, and/or matching a polarization state of the transmitted light.

Further, the device aperture may be arranged in the transmitting part for transmitting the light beam(s) and in a receiving mitting part for receiving corresponding back-reflected light beam(s) and extending to the light detector.

Further, the devices as explained herein are, due to the respective beam profile redistributor, typically configured to emit (during normal device operation) an output light beam which has, compared to a further (virtual) output light beam corresponding to the device without the beam profile redistributor, a (cross-sectional or radial) beam intensity profile with the following properties: at least substantially the same or an enlarged boundary, in particular in the near field and/or at the beam profile redistributor, a redistributed beam intensity profile in the near field resulting in a lower output light power within a given measuring aperture (typically outside the device and/or having a lower size than an effective output aperture of the device for the output light beam) at one or even all positions along the optical path in the near field, and at least substantially the same beam intensity profile in the far field.

Since the near field properties of the output light beams are changed by the beam profile redistributor without affecting the far field properties, eye-safety may be ensured in a comparatively simple and compact way even with a small transmission or emission (output) aperture of the device.

The output aperture of the device may also be used as input aperture of the device for receiving a back-reflected (back-scattered) light beam. In these embodiments, the common input/output aperture of the device is also referred to as device aperture.

The given measuring aperture is typically different to the output aperture of the device and the device aperture, respectively, typically outside the device and/or typically defined by the respective safety standard, e.g. EN 60825-1:2007. Note that the transmission aperture of the device is typically larger than e.g. the 7 mm sized measuring aperture Class 1 laser safety.

The device typically meets the requirements of the respective safety standard, e.g. a Class 1 laser safety standard.

Accordingly, the output light power of the output light beam can fulfill eye safety requirements when the device is operated in a normal mode, in which the internal light source is operated at rated power, in particular in the near field outside a housing of the device.

The given aperture may be chosen in accordance with an applicable eye safety standard for laser devices. As such, both the size of the given aperture as well as its position may depend on the wavelength, the optical device and whether the applicable eye safety standard requires an evaluation with binoculars. In particular, for a wavelength in a range from 400 nm-1400 nm without binocular evaluation, the given aperture may be required to have a diameter of 7 mm. Since lasers operating in this wavelength range are often used, a 7 mm-sized given aperture is used for the results presented below.

The given aperture may have an at least substantially elliptical shape, an at least substantially circular shape, an at least substantially rectangular or an at least substantially square shape, in particular a circular shape of about 5 mm to about 15 mm diameter, more typically of about 6 mm to about 9 mm diameter, even more typically of about 7 mm diameter, or a square shape of about 5 mm to about 11 mm base length, more typically of about 5 mm to about 9 mm base length, even more typically of about 7 mm base length.

The devices explained herein may in particular meet the eye safety condition that a maximum integral light power ∫I(x,y)=P of a circular given (measuring) aperture of 7 mm diameter in the near field is below a safety threshold A7. This results in a corresponding (minimum) effective emission area A_{eff7} ensured by the device of the (at least one) light beam in the near field of:

$${A}_{eff 7} = \frac{{A}_{7} P}{max [ I ( x , y ) ⊗ {circ ( x , y )}_{7 mm} ]} with$$

$$\begin{matrix}{circ ( x , y )}_{7 mm} = 1 & within the circle with 7 mm diameter centered at ( x , y ) \\ = 0 & otherwise\end{matrix}$$

$$and max [ I ( x , y ) ⊗ {circ ( x , y )}_{7 mm} ] - maximum of convolution of I ( x , y ) and circ {( x , y )}_{7 mm}$$

The area of the given aperture is typically in a range from about 9 mm² to about 121 mm², more typically in a range from about 25 mm² to about 81 mm², and even more typically in a range from about 35 mm² to about 50 mm², for example about 38 mm² or about 49 mm².

The light source is typically a laser, in particular a vertical-cavity surface-emitting laser.

Further, the beam profile redistributor is typically arranged downstream from and/or next to the light source.

That two light beams have substantially the same beam intensity profile intends to describe that the respective normalized intensity profiles of the light beams (intensity profile normalized to a respective peak value, e.g. in %), in a given radial plane (orientated perpendicular to the central ray of the respective beam), substantially match, i.e. differ from each other by less than 10% or even 5% at least on average and/or within a common bounding box enclosing a given percentage of the beam power in a range from about 90% to about 99%, in particular about 95% of the beam power. The beam power in the given radial plane may differ, for example by a few percent due to losses resulting from the beam profile redistributor. However, these losses may be compensated by increasing the power of an internal light source producing the input light beam accordingly. Thus, the output light beam and the virtual output light beam may also have at least substantially the same absolute beam intensity profile.

Likewise, that two light beams have substantially the same (radial or cross-sectional) boundary (also referred to as edge herein) intends to describe that a distance between the respective boundaries enclosing the given percentage of the beam power is, in the given (radial/cross-sectional) plane, less than 10% or even 5% of a perimeter of one or both of the boundaries.

The bounding box may be situated at a position with respect to the optical path where the output light beam has a waist. The bounding box may be a minimum bounding box of the output light beam, i.e. the bounding box with smallest area in the near field. Accordingly, the respective output light power may refer to a respective maximum or peak value within near field (at the measuring aperture).

According to embodiments, the (at least one) output light beam includes, in the near field and/or at the beam profile redistributor and in the bounding box, an enlarged boundary compared to the (at least one) further output light beam.

In other embodiments, the (at least one) output light beam includes, in the near field and/or at the beam profile redistributor and in the bounding box, at least substantially the same boundary compared to the (at least one) further output light beam.

In the latter embodiments, the device may include an optical path and a beam profile redistributor arranged in the optical path to receive an input light beam. The beam profile redistributor is configured to convert the received input light beam so that an output light beam of the device includes, in a near field and/or at the beam profile redistributor, and in a bounding box for the output light beam (along the optical path in NF), at least substantially the same boundary but a redistributed beam intensity profile compared to a further output light beam when the beam profile redistributor is not present. Within a given measuring aperture at a position along the optical path in the near field, an output light power of the output light beam is lower compared to the further output light beam. In a far field, the output light beam and the further output light beam have at least substantially the same beam intensity profile.

The optical path or paths are typically not changed by the beam profile redistributor. Further, the beam profile redistributor may result in optical losses of at most 5% or even at most 3% (with respect to total output light beam power).

In particular, the beam profile redistributor may at least substantially only redistribute the rays of the light beam in the near field, either with respect to one radial axis (perpendicular to the optical axis) or even with respect two typically orthogonal radial axes.

More particular, the beam profile redistributor is typically configured to change an order of light rays in the output light beam compared to the further (virtual) output light beam when the beam profile redistributor is not present without substantially changing the light beam boundary and/or without substantially changing a light beam divergence.

Even more particular, the beam profile redistributor may be configured to change the order of light rays such that a light ray of the input light beams which are near the an edge or boundary of the input light beam are redirected to a corresponding light ray of the output light beam which is near a center line or center ray of the output light beam, and/or such that light rays of the input light beam which are near a center line or center ray of the input light beam are redirected to corresponding light rays of the output light beam which are near an edge or boundary of the output light beam.

Typically, the closer the light ray of the input light beam is to the center line of the input light beam, the closer the corresponding light ray of the output light beam is to the boundary or edge of the output light beam.

Likewise, the closer the light ray of the input light beam is to the center line of the input light beam, the closer the corresponding light ray of the output light beam may be to the edge of the output light beam.

The beam profile redistributor may be arranged in the optical path to receive a divergent input light beam and configured to transmit a divergent intermediate light beam (to be collimated prior to outputting) having at least substantially the same angular span as the received divergent input light beam, and to convert light rays of the input light beam having a respective incident angle, into a corresponding light ray of the intermediate light beam, such that the light ray of the intermediate light beam have an exit angle which is different to the incident angle (angle of incidence).

Typically, the beam divergence relates to the boundary of the beam and an effective beam perimeter containing a given percentage of typically 95% of the beam power, respectively.

Typically, the lower an absolute value of the angle of incidence is, the higher an absolute value of the exit angle is, and/or the higher an absolute value of the angle of incidence is, the lower an absolute value of the exit angle is.

Further, the beam profile redistributor is typically arranged in the optical path and configured such the redistributed beam intensity profile is at least substantially maintained up to a distance from the beam profile redistributor and/or an optical outlet of the device of at least 1 m, more typically at least 2 m or 3 m, and even more typically at least 5 m, and/or that the far field begins outside the device, in particular at a distance from the beam profile redistributor and/or the optical outlet of the device of at least 10 m or even 20 m. However, these values may also depend on divergence and/or size of the output light beam.

The beam profile redistributor may include a prism, in particular a prism with a base oriented parallel in the optical path and/or mirror symmetric with respect to the optical path and a central ray representing the optical path, respectively.

The beam profile redistributor may even be implemented by one prism only. This enables a particularly simple, robust and cost-effective implementation. In particular, the prism may be a prism with 6-sided polygon base (side), more particularly a right hexagonal prism/6-prism with six rectangular side faces. Such a prism may redistribute the rays of the light beam in the near field compared to the rays of the incident light beam with respect to a radial axis which is perpendicular to both the optical axis and to the normal direction of the polygon base.

Instead of the hexagonal prism another (transparent) body having corresponding pairs of typically adjacent refractive surfaces may be used, in particular, refractive surfaces adjacent or even adjoining at least close to a center light ray and the optical axis respectively.

Alternatively, or in addition, the beam profile redistributor may include an axicon, i.e. an optical element (lens) with a conical surface for transforming an input light (laser) beam into a ring shaped (Bessel-like) output light beam, in particular an axicon with a base oriented parallel in the optical path and/or mirror symmetric with respect to the optical path and a central ray representing the optical path, respectively.

Further, beam profile redistributor may be implemented as and/or may include at least one of the following optical elements (arranged downstream from the light source in the optical path): a lens, in particular an aspherical lens, a (Gaussian-to) top-hat converter, a diffractive optical element such as a grating, a phase shifter, a meta surface, in particular a meta surface comprising nano-antennas, a liquid crystal display (LCD), a liquid crystal on silicon (LCOS), a reflector such as a digital micromirror device (DMD), and a set of reflectors, in particular at least two mirrors such as a micromirror array.

The beam profile redistributor may also include a pair of prisms or a pair of axicons. This also enables particularly simple, robust and cost-effective implementations of eye-safe optical devices with small aperture.

The two prisms of the pair of prisms are typically at least substantially equally shaped and/or implemented as respective right trigonal prisms/3-prisms (with three rectangular side faces).

Typically, the two prisms are at least substantially centered with respect to each other and/or with respect to the optical axis, are spaced apart from each other, are arranged at least substantially mirror symmetric with respect to the optical axis and/or a plane substantially perpendicular to the optical axis, and/or comprise respective base surfaces which are parallel to each other, perpendicular to the optical axis at their respective position and/or are facing away from each other.

The prisms may be identical in shape and size, and/or with respect to optical properties for the received light beam, but positioned at different orientations.

Using two trigonal respective prisms also allows for redistributing the rays of the light beam in the near field compared to the rays of the incident light beam (and the virtual output light beam) with respect to a radial axis which is perpendicular to both the optical axis and to the normal direction of the base side.

Further, the beam profile redistributor may include a pair of (typically equal shaped, but positioned at different orientations with facing conical faces) axicons or two pairs of prisms, in particular two pairs of prisms which are rotated with respect to each other and/or with respect to the optical axis.

This also allows for redistributing the rays of the transmitted light beam in the near field (without substantially affecting the far field properties) compared to the rays of the incident light beam a transmitted light beam without the beam profile redistributor, respectively, with respect to two radial axes in a comparatively simple and compact manner.

Further, the beam profile redistributor may include and or be provided by one or more one-piece partial beam splitter.

In a further embodiment, a LIDAR device includes an optical path, and a beam profile redistributor arranged in the optical path for receiving an input light beam and configured to convert the received input light beam into at least one output light beam. In a cross-section, which is at least substantially parallel to the optical path (at least at and/or in the beam profile redistributor), in particular in a respective cross-section including the optical path (or even in several respective cross-sections), the beam profile redistributor includes a first pair of adjacent refractive surfaces, and a second pair of adjacent refractive surfaces. The first pair of adjacent refractive surfaces is arranged between the input light beam and the second pair of adjacent refractive surfaces. The second pair of adjacent refractive surfaces is arranged between the first pair of adjacent refractive surfaces and the at least one output light beam.

The cross-section may represent a symmetry plane of the beam profile redistributor.

The adjacent refractive surfaces of a respective pair may adjoin in the cross-section.

Further, the first pair of adjacent refractive surfaces may be arranged at a first angle with respect to each other which is larger than 90°.

The second pair of adjacent refractive surfaces may be arranged at a second angle with respect to each other which is larger than 90° and/or at least substantially matches the first angle.

Typically, the first pair of adjacent refractive surfaces and the second pair of adjacent refractive surfaces are arranged at least substantially mirror symmetric with respect to each other and/or with respect to the optical path.

The first pair of adjacent refractive surfaces and the second pair of adjacent refractive surfaces are typically arranged one behind the other with respect to the optical path, in particular without any further light deflecting element or structure in between.

At least one of the first pair of refractive surfaces and the second pair of refractive surfaces may be provided by an axicon or a prism of the beam profile redistributor.

To achieve two-axis beam redistribution, two prism rotated against each other around the optical axis (by) 90° or a single pyramidal prism (providing both pairs) may be used.

The (LIDAR) device may include a single light source, several light sources or a plurality of light sources emitting a respective light beam that may be collimated by a collimator (arranged in the optical path upstream from the beam profile redistributor) on to the first pair of adjacent refractive surfaces for forming the input light beam may. Alternatively or in addition, the devices explained herein may include a (further) collimator for collimating an intermediate light beam emitted from the beam profile redistributor. The collimator(s) may be arranged next to or even at the beam profile redistributor. Further, the collimator(s) may collimate the respective light beam(s) with respect to one or two-axis.

Further, the LIDAR device may include an optical scanning device and/or a scanner arranged downstream in the optical path to receive and deflect the (at least one) output light beam.

In a further embodiment, a one-piece partial beam splitter for splitting an incident light beam into two light beams includes a first transmittance for a first transverse wave of the incident light beam, the first transverse wave comprising a first wavelength and a first polarization, and a second transmittance for a second transverse wave of the incident light beam, the second transmittance being larger than zero and lower than the first transmittance, the second transverse wave including a second wavelength at least substantially matching the first wavelength, and a second polarization different to the first polarization.

The second polarization may be orthogonal to the first polarization.

Further, the one-piece partial beam splitter may be configured for splitting an incident infrared (IR)-light beam into two respective IR-light beams.

The first transmittance is typically at least about 0.97, more typically at least about 0.98 or even 0.99.

The second transmittance is typically at least about 0.5 and/or at most about 0.7. In particular, the second transmittance may be about half of the first transmittance and about 0.5, respectively, or about two third of the first transmittance and about 0.67, respectively.

Further, the one-piece partial beam splitter typically includes an absorptance for at least one of the first transverse wave and the second transverse wave of at most about 0.04, more typically at most about 0.03 or even 0.02.

The partial beam splitter may in particular include a first region which is at least substantially transparent for the incident light beam, and a second region which is at least substantially transparent for the first transverse wave of the incident light beam, and at least substantially reflective for the second transverse wave of the incident light beam.

For eye-safety reasons, an extension of the first region, in particular a diameter of the first region (in a direction perpendicular to an emitting or receiving surface of the partial beam splitter) and/or an extension of the second region, in particular of a diameter of the second region is typically at most 7 mm.

The partial beam splitter may have several first regions and several second regions.

Via the area ratio of the first and second regions, the beam splitting properties of partial beam splitter may be tuned.

In particular, an area of the first region may be equal to or greater than an area of the second region.

Likewise, a total area of the first region(s) may be equal to or greater than a total area of the second region(s).

If the total area of the first region(s) is equal to the total area of the second region(s), the first transmittance is about (slightly, typically less than 1 percent or even 0.2 percent lower due to losses) 1, and the second transmittance is about (slightly, typically less than 1 percent or even 0.2 percent lower due to losses) 0.5.

If the total area of the first region(s) is equal to two times the total area of the second region(s), the first transmittance is about 1, and the second transmittance is about 0.67 (⅔).

The first and second area(s) may also be partially reflective for the first and second transverse waves.

The one-piece partial beam splitter may include a carrier which is at least substantially transparent for (the wavelength(s) of) the incident light beam. The (at least substantially transparent) carrier may be substantially shaped as a plate and/or a as wafer, and/or include or even be made of glass.

Typically, a structured layer is arranged on the carrier. The structured layer may include and/or be made of a multilayer stack of dielectric materials with variable thicknesses and/or refraction indices, and/or may include a single metallic layer.

The one-piece partial beam splitter may be manufactured at comparatively low cost and/or on wafer-level using standard processes known in thin film technology, in particular chemical or physical (material) deposition, e.g. chemical vapor deposition, and lithographic structuring.

One or more one-piece partial beam splitters may be used as or in the beam profile redistributor of the devices explained herein.

In particular, a device may, in an embodiment, include an optical path, and a one-piece partial beam splitter as explained herein which is arranged in the optical path for splitting a received incident light beam into two output light beams (in NF).

Accordingly, a better trade-off between the effective emission area and the receiving efficiency may be achieved.

The device may include two, three or even more one-piece partial beam splitters arranged sequentially in the optical path.

The one-piece partial beam splitters may be different with respect to at least one of: a size, a shape, an optical property for the incident light beam, in particular a ratio between an area of a first region (of the respective one-piece partial beam splitter), which is at least substantially transparent for the incident light beam, and an area of a second region (of the respective one-piece partial beam splitter) which is at least substantially transparent for a first transverse wave of the incident light beam and at least substantially reflective for a second transverse wave of the incident light beam of different polarization, and/or a second transmittance of the second transverse wave of the incident light beam.

The at least two one-piece partial beam splitters may even be implemented on a single optical element, in particular, a respective (glass) prism.

Further, the device may include at least one of:
a light source,
a polarization shaping device (PSD) such as a quarter wave plate arranged in the optical path between the light source and the one-piece partial beam splitter(s),
a beam splitter arranged in the optical path,
a mirror arranged in the optical path, and
a polarization independent beam splitter arranged in the optical path, in particular a so-called x/(1−x)-beam splitter, with 0.5<=x<1, e.g. a 50/50-beam splitter (x=0.5) or an 80/20-beam splitter (x=0.8) that is polarization independent.

The devices as explained herein are typically optical devices and/or devices for emitting a light beam, in particular a respective device for emitting a light beam and receiving a back-reflected light beam, more particular a back-scattered light beam.

The device may in particular be a LIDAR device, a LIDAR system (or a part thereof), an optical scanning device and/or include a scanner arranged in the optical path to receive and deflect the output light beam, after optionally being collimated and/or being redirected towards the scanner, with an at least substantially maintained redistributed beam intensity profile (in the near field).

The scanner may in particular be a rotating polygon scanner.

The herein provided systems, structures and methods which are related to entity/identity resolution can be applied to fields from many kinds of industries.

The following examples are described using specific language which should not be construed as limiting the scope of the appending claims. The drawings may not be scaled and are for illustrative purposes only. For clarity, the same elements or manufacturing steps have been designated by the same references in the different drawings if not stated otherwise.

A laser is one example of a light source that can be used in a LIDAR system. As with any sensing system, in order for a LIDAR-based sensing system to be fully adopted by the automotive industry, the system should provide reliable data enabling detection of distant objects. Thus, operating in maximum illumination power of LIDAR systems is preferred. Currently, however, the maximum illumination power of LIDAR systems is limited by the need to make the LIDAR systems eye-safe. For example, LIDAR systems are required to prevent damage to the human eye which can occur if a projected light emission enters the eye's cornea and lens, causing thermal damage to the retina.) In particular, operating with a focused or collimated laser beam may be potentially hazardous to human unaided eyes or even the skin.

Laser beams are divergent, the laser flux decreases with distance from the emitter along the beam transmission direction. As such, the potential hazard is higher closer to the laser source—in the Near Field (NF) of the laser, and decreases with distance of a target from the laser device. Furthermore, the emitted beam has a non-uniform intensity profile in the Near Field (NF). For example, the laser beam cross section or ‘spot’ may have a gaussian distribution, with the highest intensity at the center of the beam, decreasing towards the periphery of the beam.

To prevent damage, laser-based devices are classified accordingly by their potential hazard level, and must fulfill respective safety requirements.

For example, according to standard EN 60825-1:2007, a maximum-allowed power, or acceptable emission limit (AEL) level is defined. For a 900 nm wavelength Class 1 laser, the AEL is 1 mW when measuring flux through a 7 mm aperture outside the device (14 mm from the point where the laser beam exits the device).

Expanding an emitted (transmitted) illumination beams may reduce the flux by increasing the spot size and spreading the beam energy over a larger area. However, expanding the emitted (transmitted) beam and enlarging the devices transmission aperture, respectively, is not always a viable solution to ensure eye-safety. Other optical elements of the device, such as a scanner in the light path, may benefit from a smaller beam spot size. The size of the scanner and other optical elements may need to scale with the size of the beam spot. Expanding the optical elements may impact size and/or cost constraints and/or performance of the LIDAR system.

In particular, expanding an emitted (transmitted) illumination beams may impact the performance of the laser device. A larger emitted beam spot size may impact the detection of back scattered light in devices with overlapping optical paths of transmitted and received back scattered light. For example, a LIDAR device may include a rotating polygon scanner to deflect laser beams towards a FOV. Light emitted towards the edge of the polygon facet during rotation may be partially incident on the edge of the polygon facet for a longer time, depending on the beam spot size. Thus, increasing the laser beam spot size would require increasing the size of the rotating polygon scanner to ensure the same functionality/performance.

Beam Redistribution with NF Perimeter (Bounding Box) Maintained

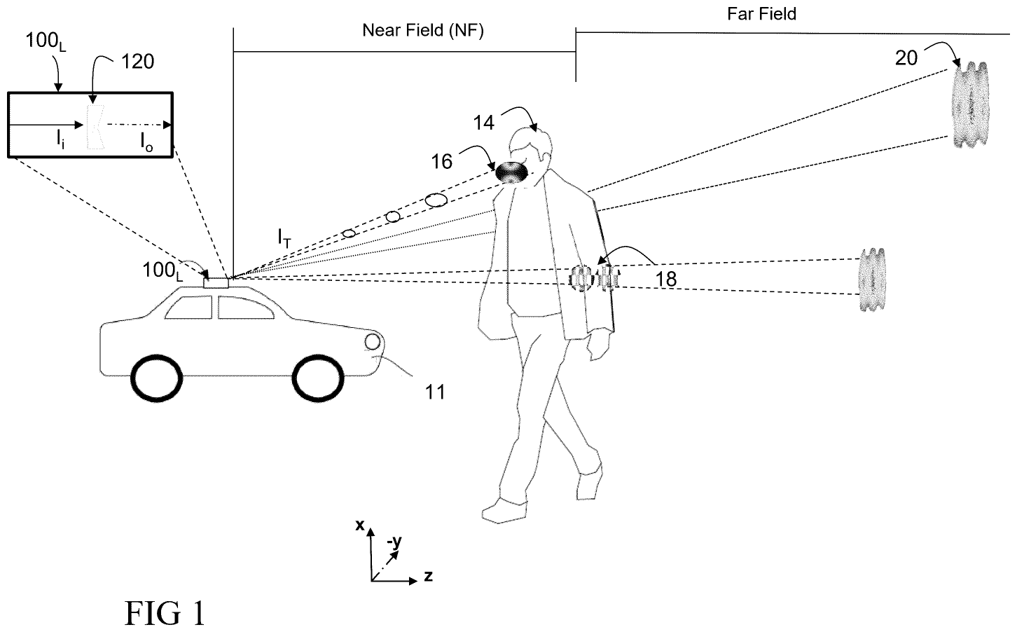

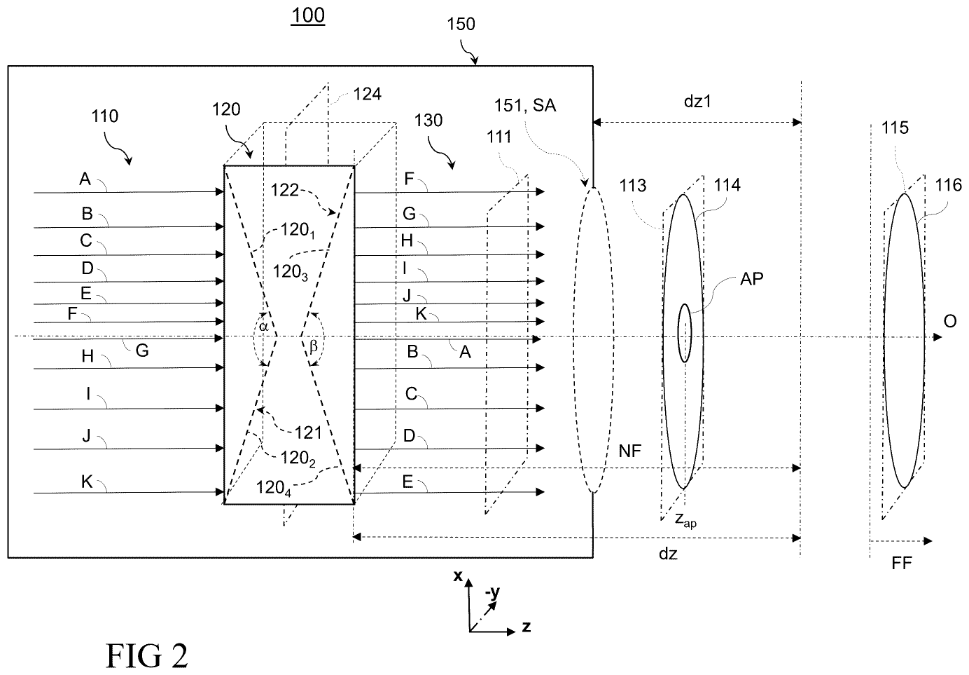

FIGS. 1, 2 are diagrams illustrating an exemplary LIDAR system 100_{L} mounted on a vehicle 11, configured to emit a light beam towards a Field of View (FOV). A magnified view of LIDAR system 1001 in FIG. 1 illustrates that the LIDAR system includes a beam profile redistributor 120, arranged in the optical path O (shown in greater details in FIG. 2 illustrating an optical device 100 for emitting a light beam that may be used as LIDAR device or LIDAR system 100_{L} or part thereof) to receive at least one input light beam Iᵢ. The at least one output light beam Iₒ of the device has a redistributed beam intensity profile 16 in the Near Field (NF), compared to at least one further output light beam when the beam profile redistributor is not present. In a far field (FF), at least substantially the same beam intensity profile 18 is received compared to the at least one further output light beam when the beam profile redistributor is not present (profile 20).

The FOV may be characterized as having a Near Field (NF) portion, starting at the LIDAR system housing, up to a defined distance along the z-axis, and a Far Field (FF) portion, from the end of the NF up to the LIDAR maximum range. In the example shown in FIG. 1, a person 14 is in the Near Field NF of the LIDAR system. The person may be a pedestrian in the vicinity of a vehicle equipped with a LIDAR system. The disclosed systems and methods may be relevant for other object such as animals, or sensitive electronic equipment, such as photodetectors. In the near field of a LIDAR system, where the potential risk for damage is greater, the beam profile is redistributed to a distribution 16 that can meet eye-safety requirements, by the beam profile redistributor 12. The beam profile is the cross section of the beam power or beam energy in plane X-Y. In the far field of the LIDAR system, the beam profile has substantially the same beam intensity profile 18 compared to a similar system without the beam profile redistributor. The near field beam intensity profile increases the eye-safety of the system, while the far field beam intensity profile does not impact the beam properties required for long range detection.

The term Near Field (NF) as used herein denotes a portion of the field of view illuminated by light coming from the laser device, at which the accumulated effect of the optical path accommodating the beam profile redistributor results in a redistributed intensity profile. In particular in the eye-safety applications of the LIDAR as described herein, the Near Field is the portion of the FOV at which the illuminated beam profile distribution is required to meet stricter eye-safety requirements. For example, the Near Field (NF) may be defined as the distance from the device aperture and up to 1 m, 2 m, 3 m up to 5 m or 7 m.

The term Far Field (FF) as used herein denotes the portion of the FOV at which the inevitable divergence of the beam illuminated by the laser device overcomes the accumulated effect of the optical path accommodating the beam profile redistributor. In the eye-safety applications of the LIDAR as described herein, the illuminated beam profile distribution at the Far Field is characterized mainly by its intensity and the suitability of the beam intensity for object detection. For example, the Far Field (FF) may be defined as the distance from the end of the Near Field (for example, 1 m, 2 m, 3 m up to 5 m or 7 m away from the device aperture and up to 15 m, 20,m, 25 m, 30 m.

In addition to the illustrated optical unit (optical components) and a sensing unit (with a light detector, not shown) for detecting back scattered light received from a typically remote object in the FOV, LIDAR system 100_{L} typically further includes: a control unit (not shown) configured to control emitting of IR-laser light beams (toward the object in the FOV to be detected) by LIDAR system 100_{L}, and its optical unit, respectively; and/or a calculating unit for calculating one or more parameters referring to the object and/or to a relationship between LIDAR system 100_{L} and the object, such as a distance between LIDAR system 100_{L} and the object or a relative velocity between LIDAR system 100_{L} and the object. The calculating unit may also be provided by the control unit.

FIG. 2 shows an optical device 100 for emitting a light beam 130. Device 100 may be used as (part of) LIDAR system 100_{L} explained above with regard to FIG. 1. In the exemplary embodiment, device 100 has a housing 150 and an optical outlet with device aperture 151 for emitting a light beam 130. In some embodiments, device aperture 151 may also be used for incoming light, in particular, back scattered light received from a typically remote object in the FOV, illuminated with one or more emitted light beams 130 in the FOV (far field FF of the light beam(s) 130), for example in a scanning mode of device 100.

As illustrated in FIG. 2, a beam profile redistributor 120 is arranged in an optical path O for receiving an input light beam 110 and converting the received input light beam 110.

In the exemplary embodiment, the optical path (central ray or center of rays) O is straight. Depending on the type and/or the particular design of optical device 100, optical path O may also be more complex, e.g. folded.

Further, beam profile redistributor 120 is configured to change the order of light rays A-K of a (transmitted) light beam. Illustrated beam redistributor 120 may have flat, typically rectangularly shaped receiving (input) and emitting (exit) surfaces for the input light beam 110 and output (emitted) light beam(s) 130, respectively. As illustrated by the dashed cuboid, the receiving and emitting surfaces beam profile redistributor 120 may be oriented parallel to each other and/or perpendicular to the optical path (central ray) O.

As illustrated by dashed lines 121, 122, beam redistributor 120 may be at least substantially mirror-symmetric with respect to one axis (x-axis in the exemplary embodiment) at least substantially perpendicular to the optical path (central ray) O and the receiving and emitting surfaces, respectively, and at least substantially mirror-symmetric with respect to a plane at least substantially perpendicular to the optical path (central ray) O. Accordingly, beam redistributor 120 may translate the position of the beams in one axis (x-axis in the exemplary embodiment). Beam profile redistributor 120 may also be referred to as one-axis beam profile redistributor.

Light rays A-C, I-K of input light beam 110 which is near an edge (boundary) of the input light beam 110 are redirected and redistributed, respectively, to corresponding light rays A-C, I-K of output light beam 130 which are nearer to a center line or central ray (optical axis) O of output light beam 130 while light rays D-H of input light beam 110 which are near center line O of input light beam 110 are redirected and redistributed, respectively, to corresponding light rays D-H of output light beam 130 which are near an edge of output light beam 130.

Accordingly, light rays A-K are redistributed with respect to one axis (x-axis in the exemplary embodiment), perpendicular to optical axis O at the location of beam profile redistributor 120 and one plane in which the optical axis lies (central y-z-plane in the exemplary embodiment), respectively. Thus, if the beam power of input light beam 110 is largest in a cross-sectional center region, such as for an input light beam 110 having a Gaussian beam profile, beam power of output light beam 130 in its cross-sectional center region may be reduced in the near field (NF) at the expense of a peripheral cross-sectional region of output light beam 130 in NF.

In the exemplary embodiment, light rays A-K are redistributed by distance (from optical axis O).

As further illustrated in FIG. 2, redistribution of light rays A-K may be achieved by two pairs of refractive surfaces of beam profile redistributor 120 which arranged one behind the other with respect to the optical axis O.

More particular, beam profile redistributor 120 provides a first pair of adjacent refractive surfaces {120₁, 120₂} and a second pair of adjacent refractive surfaces {120₃, 120₄} arranged between downstream from the first pair of refractive surfaces {120₁, 120₂}.

In the exemplary embodiment, the adjacent refractive surfaces 220₁, 220₂ of the first pair are touching each other at a first angle α, the adjacent refractive surfaces 2203, 2204 of the second pair of adjacent refractive surfaces are touching each other at a second angle β.

The first pair of adjacent refractive surfaces {120₁, 120₂} and the second pair of adjacent refractive surfaces {120₃, 120₄} are arranged (at least substantially) mirror symmetric with respect to each other and with respect to the optical path O (at beam profile redistributor 120, within beam profile redistributor 120, and/or next to beam profile redistributor 120).

Accordingly, the first angle α and the second angle β are at least substantially equal (α=β) in the exemplary embodiment.

Typically, the closer a light ray of the input light beam 110 is to the center line O, the closer the corresponding light ray of the output light beam 130 is to the edge of the output light beam 130 and vice versa.

Accordingly, the (output) light power of output light beam 130 when measured using an aperture AP, in particular an aperture as defined by a safety standard, for example a respective Class 1 laser standard, may be substantially reduced compared to a device/setup without beam profile redistributor 120, for example by at least about 35% or even 40%. In FIG. 1, aperture AP is illustrated as a series of apertures 16 located in the Near Field between the laser device 100 and the pedestrian 14. In FIG. 2, aperture AP is illustrated within the Near Field. As illustrated, aperture AP for measuring eye-safe beam intensities is located at position zₐₚ—at a distance from the laser output smaller than dz, or located at a distance from the laser device housing smaller than dz1.

The Near Field beam intensity profile redistribution may be achieved without substantially changing the far field properties of light beam 130. The beam intensity profile in FF outer boundary of light beam, eye-safety requirements may be ensured during normal device operation without reducing light power and increasing cross-sectional size of light beam 130.

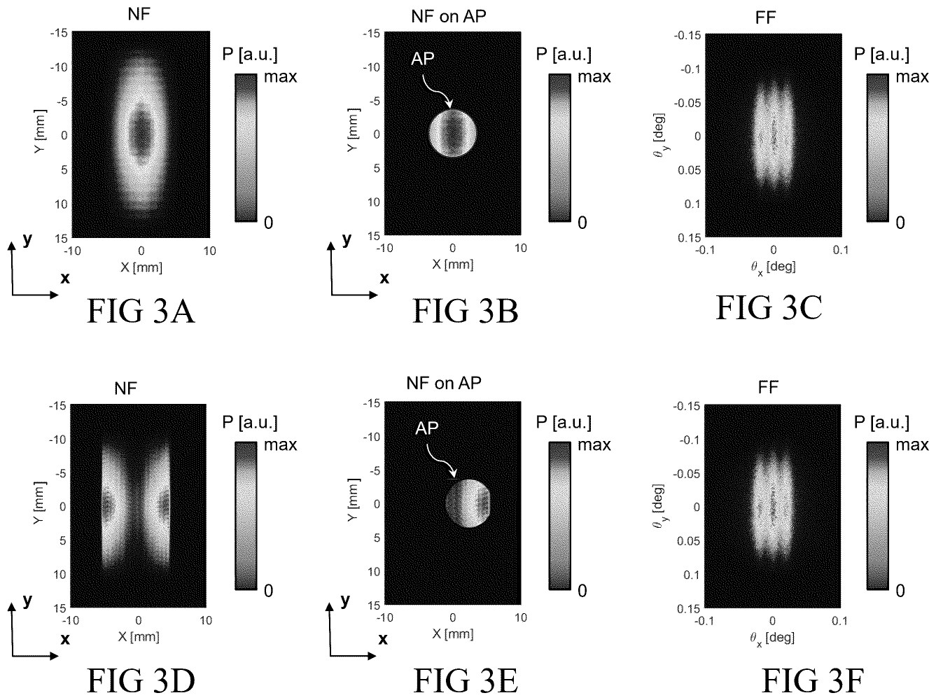

This is illustrated in FIGS. 3A to 3F showing simulations of beam intensity profiles of light beams 130 measured in NF at a position zₐₚ along the optical path outside device 100 and in FF with and without redistributor 120. Each figure corresponds to a density plot and is provided with a linear intensity/power scale.

In the exemplary embodiment, beam intensity profiles shown in FIGS. 3A-3C correspond to beam intensity profiles (radiant flux/power P in radial planes 113 (bounding box in NF downstream from device aperture 151 in FIG. 2) and 115 perpendicular to axis O) of an output light beam of device 100 without beam profile redistributor. FIG. 3D-3F correspond to beam intensity profiles of output light beam 130 of device 100 with a beam profile redistributor 120.

The simulated beam intensity profiles shown in FIGS. 3D-3F were produced with reference to redistributor 120 shown in FIG. 2, consisting of two spaced apart right trigonal prism 121, 122 which are at least substantially transparent to infrared input light beam 110. The exemplary prisms 121, 122 are identically shaped, and arranged mirror-symmetric in optical path O with respect to each other and a central radial plane 124 of beam profile redistributor 120, respectively (central x-y plane of beam profile redistributor 120 in the exemplary embodiment).

FIGS. 3A, 3D show the intensity profiles in NF. As can be seen, the boundary (114 in FIG. 2 within bounding box 113 for the output light beam) of output light beam 130 obtained for device 100 with (FIG. 3D)/without (FIG. 3A) beam profile redistributor 120 is almost the same. Different thereto, in NF, a substantially Gaussian intensity profile (FIGS. 3A, 3B) of output light beam obtained for device 100 receiving an incident light beam (110 in FIG. 2) of Gaussian intensity profile without beam profile is converted by beam profile redistributor 120 to a redistributed beam profile (FIGS. 3D, 3E) in NF. The redistributed beam profile (FIGS. 3D, 3E) has a substantially 2-fold rotational symmetry (substantially mirror-symmetric with respect to the x-axis and a central x-z plane, respectively).

Accordingly, the total light power within the exemplary central measuring aperture AP (with 7 mm in diameter) is substantially reduced, by a factor of between 1.3-2.

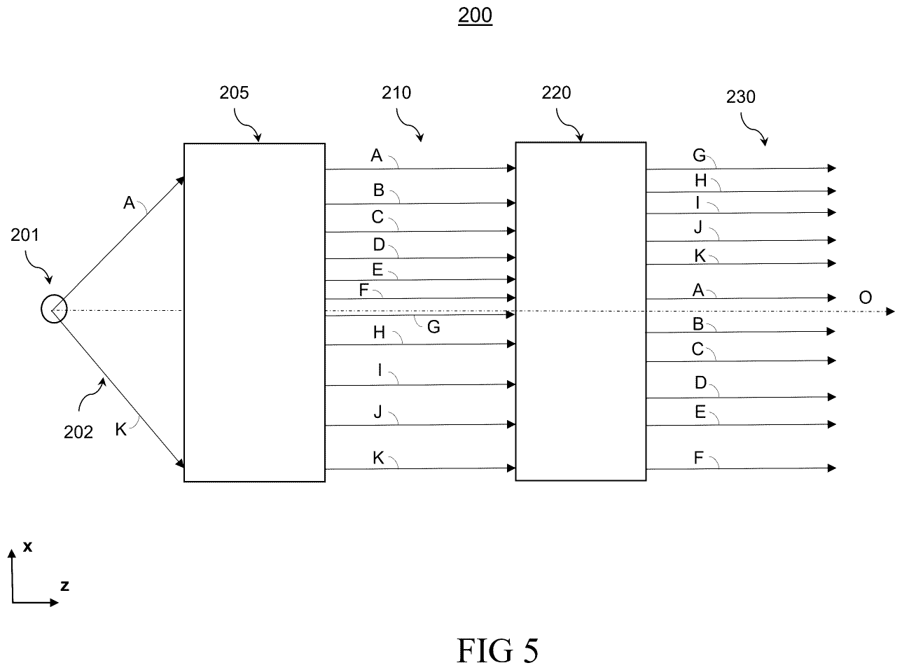

A more detailed analysis reveals that for device 100 with a beam profile redistributor 120 the total light power within any 7 mm measuring aperture AP is reduced by at least 20-50%, including in the aperture of maximum light power. In several embodiments, the aperture of maximum light power may not be central, see e.g., FIG. 5B).

Different thereto, intensity profiles in FF are substantially the same as can be seen from FIGS. 3C, 3F according to which both outer boundary (116 in FIG. 2) of the output light beam and intensity profile are substantially matching.

Note that beam intensity P in FIGS. 3C, 3F is plotted as respective function of spatial angles (aperture angles) θₓ, θ_{y} in contrast with coordinates x, y. This is more appropriate because the light beam is (slightly) divergent in FF typically beginning at least a distance of at least 10 m or even 20 m from the beam profile redistributor 120 and an optical outlet/device aperture 151, respectively.

The redistributed NF beam intensity profile may be at least substantially maintained up to a distance dz, dz1 from the beam profile redistributor 120 and the device aperture 151, respectively, of e.g. up to 1 m, more typically up to 3 m, and even more typically up to 5 m or 7 m, in particular in embodiments referring to laser scanning and LIDAR devices, respectively.

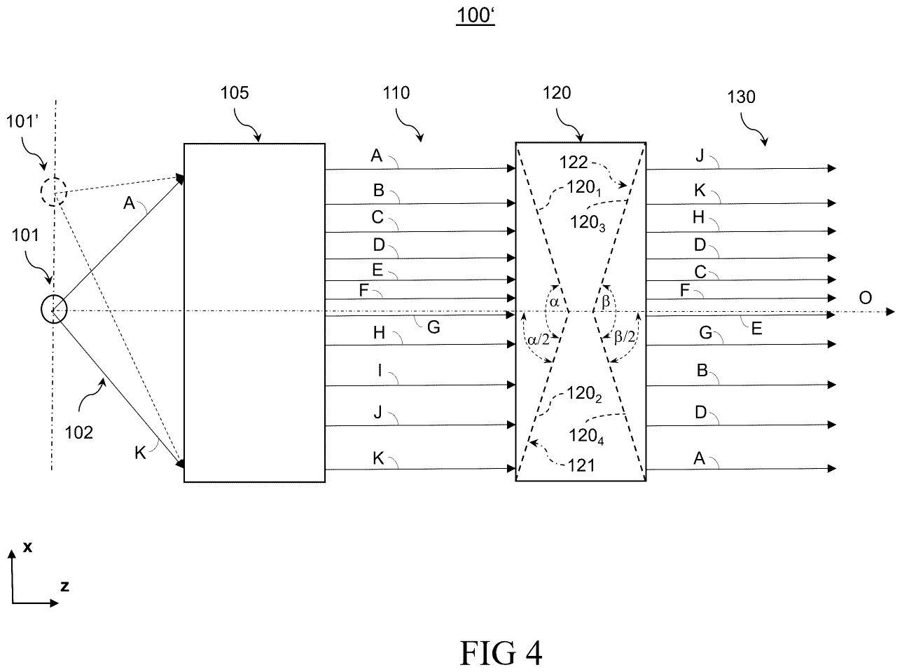

FIG. 4 shows a device 100′ for emitting a light beam 130. Device 100 is similar to device 100 explained above with respect to FIGS. 2, 3, but further includes a collimator 105 arranged in optical path O to convert a divergent light beam 102 emitted from a light source 101, such as a semiconductor laser, in particular an edge-emitting (semiconductor) laser, or a vertical-cavity surface-emitting laser (VCSEL), to a typically substantially collimated input beam 110 to beam profile redistributor 120.

Further, collimator 105 may be used to redirect light beam 102 to beam profile redistributor 120 if desired as indicated by (alternative) light source 101′ in FIG. 4.

Furthermore, it is also possible to use the (single) one-axis beam profile redistributor 120 for an array of light sources 101, 101′, e.g. lasers, instead of a single light source 101, 101′.

For this purpose, the one-axis beam profile redistributor 120 may be arranged within a collimator, i.e. within the empty space between two collimation lenses. This allows for reducing costs and/or complexity of assembly.

In particular, light beams 102 from light sources 101, 101′ of an array of light sources 101, 101′, for example up to 4, up to 8, up to 16, up to 32 or even more light sources 101, 101′ arranged in a plane, on a curve or even on a line as illustrated by the dashed-dotted line in FIG. 4, may be redistributed in parallel by one one-axis beam profile redistributor 120 (or one two-axis beam profile redistributor explained below with respect to FIGS. 5 to 8) in NF without substantially changing the beam intensity profiles in FF.

More particular, when using an array of light sources 101, 101′, the intensity profile of beams 130 of redistributed corresponding incident light beams 110 with slight angular deviations may substantially overlap in NF (resulting in similar, in some instances slightly smeared profiles compared to FIGS. 3D, 3E), and form separate beams 130 in FF, each of which may have an intensity profile as shown in FIGS. 3C, 3F.

As further illustrated in FIG. 3, each of refractive surfaces 120₁, 120₂ may form an acute angle α/2 with the optical axis O, and each of refractive surfaces 120₃, 120₂ may form an acute angle β/2 (typically matching α/2).

FIG. 5 shows a further device 200 for emitting a light beam 230. Beam profile redistributor 220 is configured to redistribute the light rays A-K of collimated light beam 210 exiting the collimator 205 to an output light beam 230 in the near field with respect to two radial axes (x-axis and y-axis).

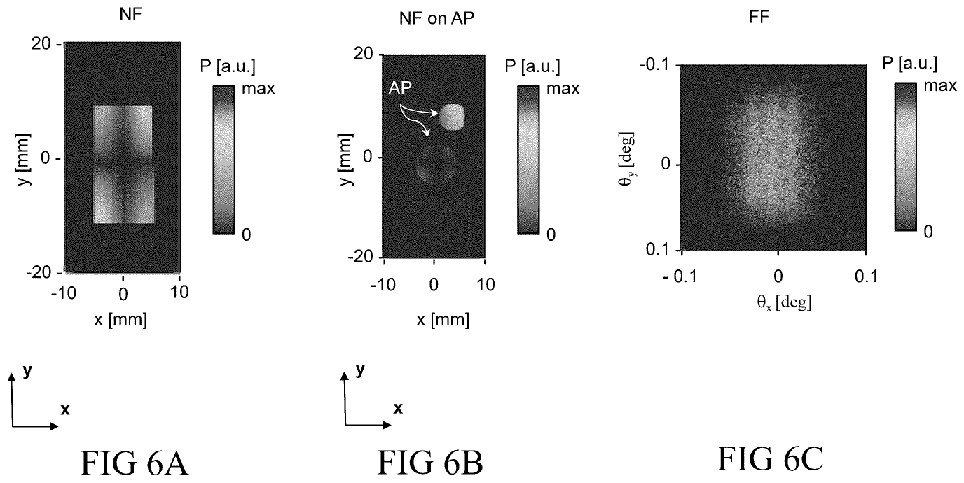

This is illustrated in FIG. 6A-C showing resulting beam intensity profiles of light beam 230 in NF (FIG. 6A) at two 7 mm measuring apertures AP in NF (FIG. 6B), i.e. a, central aperture and the aperture of maximum total light power. FIG. 6C shows the beam intensity profile in FF.

Due to the two-axis redistribution of the incident light beam, an NF beam intensity profile with substantially 4-fold rotational symmetric is formed, while the FF properties remain substantially unchanged by beam profile redistributor 220 (data not shown).

Furthermore, an even lower total light power in the 7 mm aperture may be achieved compared to the single axis redistribution illustrated in FIG. 3.

The simulation results shown in FIG. 6A-C were obtained with reference to the use of two pairs of right trigonal prism, each pair consists, as described with regard to FIG. 2, of two spaced apart right trigonal prism 121, 122 which are at least substantially transparent to infrared input light beam 110. The exemplary prisms 121, 122 are identically shaped, and arranged mirror-symmetric in optical path O with respect to each other and a central radial plane 124 of beam profile redistributor 120, respectively. The two pairs of prisms are rotated with respect to each other by 90° around optical axis O. Beam profile redistributor 220 may also be referred to as two-axis beam profile redistributor.

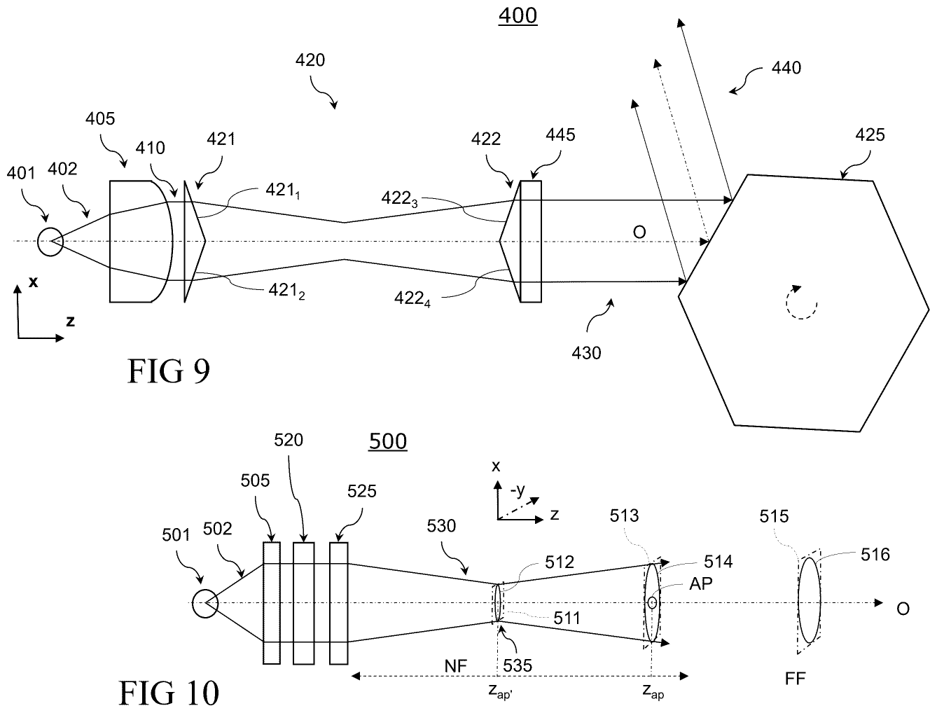

Two-axis beam profile redistributors may also be realized using a single pyramidal prism. In this embodiment, collimation in the two axes is additionally performed, e.g. using collimating lenses as e.g. explained below with regard to FIG. 9.

In other embodiments, two-axis beam profile redistributors is implemented using a meta surface of a diffractive/refractive optical elements, conical prisms, more particular axicons, instead of the trigonal prisms.

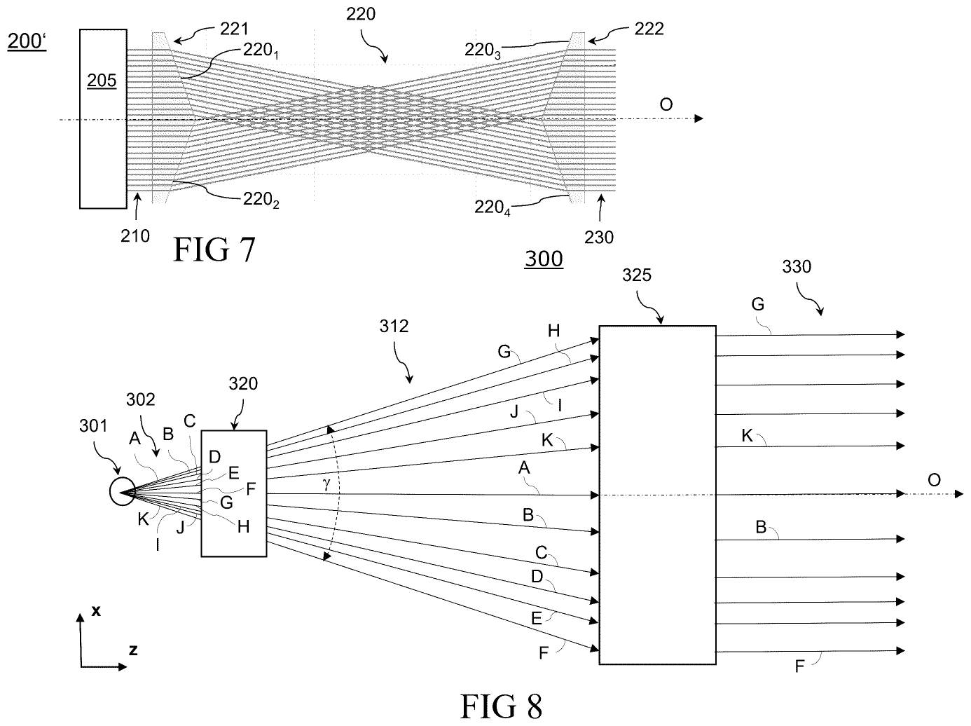

FIG. 7 partially shows a device 200′, comprising a two-axis beam profile redistributor 220 implemented as a double-axicon system with a collimator lens 205 and two axicons 221, 222, (e.g., two AX1220-B axicons of Thorlabs, Inc.), facing each other with their substantially conical surfaces.

Accordingly, the parallel input light beam 210 is shaped by axicon 221 to a substantially ring-shaped, divergent intermediate light beam with redistributed light rays that is reshaped into a substantially parallel output light beam 230 by axicon 222.

In embodiments, referring to axicon using beam profile redistributors, each pair of adjacent refractive surfaces {220₁, 220₂} and {220₃, 220₄} are provided by one respective surface. Further, the refractive surfaces {220₁, 220₂} as well as the refractive surfaces {220₃, 220₄} may adjoin each other only in (illustrated) cross-section(s) which include the optical axis O.

FIG. 8 shows another device 300 for emitting an output light beam 330. Device 300 is similar to device 100′ explained above with respect to FIG. 4, and also has a collimator 325. However, beam profile redistributor 320, which may be implemented as explained above with regards to FIGS. 2, 4, 5, i.e., with prisms, is arranged between the light source 301 and collimator 325 for collimating a divergent redistributed intermediate light beam 312 received from beam profile redistributor 320.

As illustrated in FIG. 8, beam profile redistributor 320 is configured to transmit a divergent intermediate light beam 312 with the same angular span y as the divergent input light beam 302 received from light source 301 and/or without substantially changing a light beam divergence, but to redistribute the light rays A-K (by angle in the exemplary embodiment) as desired for eye-safety reasons in NF. Beam profile redistributor 320 may include an optical meta surface including a 2D structured phase plate, a liquid crystal on silicon (LCOS) element, or phase volume (i.e. a volume holographic structure). The meta surface may be a 2D meta surface. The phase volume may be a 3D element. Alternatively, the beam profile redistributor 320 may include a mircrolens array, for example, a 2D microlens array.

FIG. 9 shows another device 400 for emitting an output light beam 430. In the exemplary embodiment, device 400 is implemented as a scanning device, for example a LIDAR device.

Accordingly, a scanner 425 is arranged in the optical path O to receive and deflect output light beam 430 received from beam profile redistributor 420 with an at least substantially maintained redistributed beam intensity profile (in NF).

In the exemplary embodiment, scanner 425 is implemented as a rotating polygon scanner. This can ensure increased eye safety without increasing the cross-sectional size of the laser beam(s) as incident on the polygon facets. As such, the size of the rotating polygon scanner may be more compact. Without beam profile redistributor 420 the cross-sectional size of the laser beam(s) would have to be increased, causing partial signals that can occur when the laser beam is incident on an edge between the polygon facets. This may be mitigated by increasing the size of the rotating polygon scanner, which negatively impacts other system constraints such as overall size, form-factor, and cost. While scanner 425 may be implemented as a rotating polygon, the invention is not limited thereto. The scanner may be implemented as a mechanical mirror, a combination of single axis mechanical rotating mirrors, a biaxial mechanical rotating mirror, a MEMs mirror, a rotating prism, or any other scanner to deflect light across a Field of View.

The device 400 may comprise a first collimating lens 405 to collimate the emitted laser beam in a first axis, and a second collimating lens 445 to collimate the emitted laser beam in a second axis perpendicular to the first axis. The beam profile redistributor 420 may be positioned between the first and second collimating lenses 405, 445. Beam profile redistributor 430 may redistribute the beam 402 in a manner similar to FIG. 3D-F in the first axis, which is collimated in the first axis, when the beam reaches beam profile redistributor 420. The beam 402 is then collimated in the second axis by the second collimating lens, 445.

Further, output light beam 430 may be (further) collimated using a collimator arranged in optical path O and/or redirected towards the scanner 425.

Further, in order to redistribute the beam 402 in a manner similar to FIG. 6A, i.e. inverting the beam profile in the X and Y axes as illustrated in FIG. 6A, and additional beam redistribution element (not shown) may be included after the second collimation lens 445.

Alternatively, the beam profile redistributor 420 may be positioned after both collimating lenses 445, i.e. after the beam 402 is collimated in both axes. Alternatively, the beam may be collimated in both axes by a single collimation lens, and the beam profile redistributor 420 may be positioned after the single collimation lens.

Beam profile redistributor 420 may include trigonal prisms 421, 422 as explained above with reference to FIG. 2 (one-axis redistributor) or two pairs thereof as explained with reference to FIGS. 5 to 8 (two axes redistributor). Optionally, beam profile redistributor 420 may be located after (downstream from) a collimator 405 for converting a divergent light beam 402 emitted from light source 402 to an intermediate light beam 410.

For example, beam profile redistributor 420 may include conical prisms instead of the trigonal prisms 421, in particular axicons as explained with reference to FIG. 7.

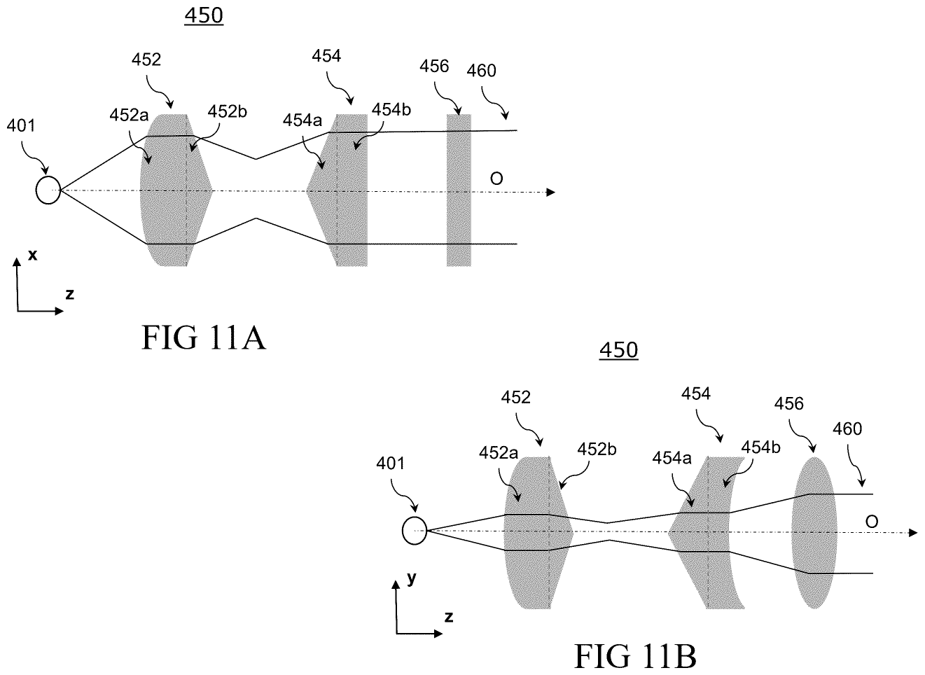

Alternatively, the beam profile redistributor components may be integrated with the collimating components, or other optical elements for adjusting the beam size. FIGS. 11A, 11B show two respective (orthogonal) cross sections of a further device 450 for emitting an output light beam 460. Device 450 may include a single collimating lens 452a to collimate the input beam in both axes, as described above. A beam profile redistributor 452b, 454a may be positioned after the single collimation lens 452. Device 450 may further include a beam expander 454b, 456 to expand the beam in one axis. For example, the beam expander 456, 454b may be positioned after (or downstream from) the beam profile redistributor 452b, 454a. If the shape of the light source (emitter) 401 is not symmetrical (e.g. an elliptical shape, or a rectangular shape, beam expander 456, 454b may further comprise a collimation lens to collimate the lens in the desired axis. For example, if the light source shape is a rectangular shape, beam expander 456, 454b may include a collimation lens. The beam profile redistributor components (for example, one of a set of prisms 452b, 454a, in particular 452b) may be integrated with the single collimating lens 452a in a single optical element 452. The beam profile redistributor components (for example, one of a set of prisms 452b, 454a, in particular 454a) may be integrated with the beam expander (456, 454b) in a single optical element 454. Integrated optical components (454, 452) reduces the overall number of optical parts, and the complexity of the system. In particular, complexity of assembling the optical components, due to the high precision of assembly typically required of each optical component in the optical system, is reduced.

Beam redistribution, as described above and illustrated in FIGS. 3D and 6A, assumes that the beams are (at least substantially) parallel when received by the receiving surface of the beam redistributor in the relevant axis. As such, to redistribute the beam profile as illustrated in FIG. 6A, the beams are to be (at least substantially) collimated in both axes (X and Y), whereas to redistribute the beam profile as illustrated in FIG. 3D, the beams are to be (at least substantially) collimated in the axes in which it is to be inverted (e.g. X or Y axis).

Positioning the beam profile redistributor after collimation in both axes enables use of a beam profile redistributor that may invert the beam profile in both axes, as illustrated in FIG. 3D, with a single beam redistribution component. The single beam redistribution component may be a pyramidal shaped optical element. Beam profile redistributor 452b and 454 a in device 450 may be pyramidal (e.g. square pyramidal) shaped optical elements to invert beams in two axes.

Additionally, the configuration outlined has the advantage of a compact system with a small form factor, in which the beam profile redistributor may be configured to redistribute the incident beam with respect to two typically orthogonal radial axes with a single component, positioned after a single collimating lens. In alternative solutions, including multiple collimating lenses, multiple beam profile redistributors may be used, thereby increasing the complexity and size of the device.

The beam expander 454b and 456 may be used when the collimation required in a first and second axis is different. For example, to form an elongated beam shape, collimation in a first axis will be different to that of the collimation in a second, orthogonal axis. As such, if a single collimation lens is used to collimate a beam in 2 axes, an additional beam expanding components may be used in order to enable formation of beam shapes as desired.

FIG. 10 shows a further device 500 for emitting an output light beam 530. Device 500 is similar to devices 100 to 400 explained above with respect to FIGS. 2 to 9.

In the exemplary embodiment, device 500 uses, similar to device 400, a beam profile redistributor 420 which is, in optical path O, arranged between two collimators 505, 525.

FIG. 10 illustrates that output light beam 530 may have a waist 535 in NF and that the total output light power may be lower than a threshold safety value when measured at any position zₐₚ of measuring aperture AP along the optical path O in NF, in particular at waist position z_{ap′}.

Accordingly, eye-safety may be ensured at any distance outside device 500.

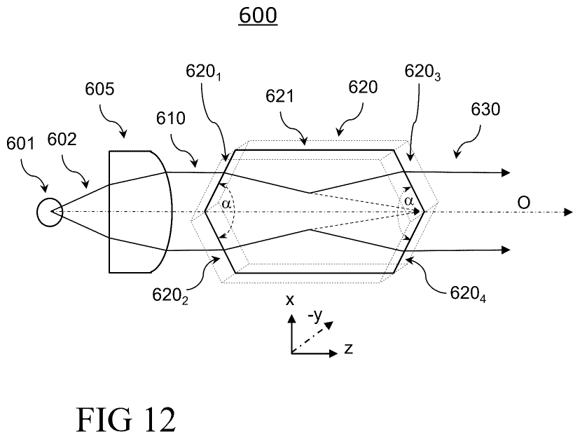

FIG. 12 shows yet a further device 600 for emitting an output light beam 630. Device 600 is similar to devices 100′, 400 explained above with respect to FIGS. 4, 9 and also has a corresponding collimator 605.

However, beam profile redistributor 620 arranged in optical path O is implemented differently, namely as a single right hexagonal prism 621 resulting in similar beam characteristics as shown in FIGS. 3D-F.

Similar to beam profile redistributor 120, 420, beam profile redistributor 620 also includes two pairs of adjacent refractive surfaces which are provided by right hexagonal prism 621, i.e. a first pair of adjacent refractive surfaces 620₁, 620₂ and a second pair of adjacent refractive surfaces 620₃, 620₄. In the exemplary embodiment, each of the rectangular refractive surfaces 620₁-620₄ forms an acute angle α/2 (0<a/2<π/2) with the optical axis O.

Refractive surfaces 620₁, 620₂ and 620₃, 620₄ may be provided by prism(s).

A single component such as single right hexagonal prism 621, compared to using a trigonal prism pair, has the advantages of reducing the number of surfaces crossed along the optical path O, reducing optical losses, and ease of assembly and alignment of optical surfaces.

Embodiments are described above mainly with reference to a single light source. The invention is not limited thereto and can be used for redistributing light generated by an array of light source. In one embodiment, multiple light sources are used. The beam profile redistributor may comprise e.g., multiple trigonal prism pairs, each pair as described with reference to FIG. 2, 4, 5. Alternatively, the beam profile redistributor may comprise pyramidal prism pairs, as described with reference to FIGS. 11A, 11B. Each of the multiple light sources may be associated with a corresponding trigonal prism pair.

Embodiments are described with reference to a LIDAR system. The invention is not limited thereto and can be used for other devices emitting light generated by a light source, such as rangefinders (e.g. for military applications), free-space optical communication, etc., which require longer range performance, but are also required to comply with eye-safety standards.

Beam Redistribution with Expanded NF Perimeter

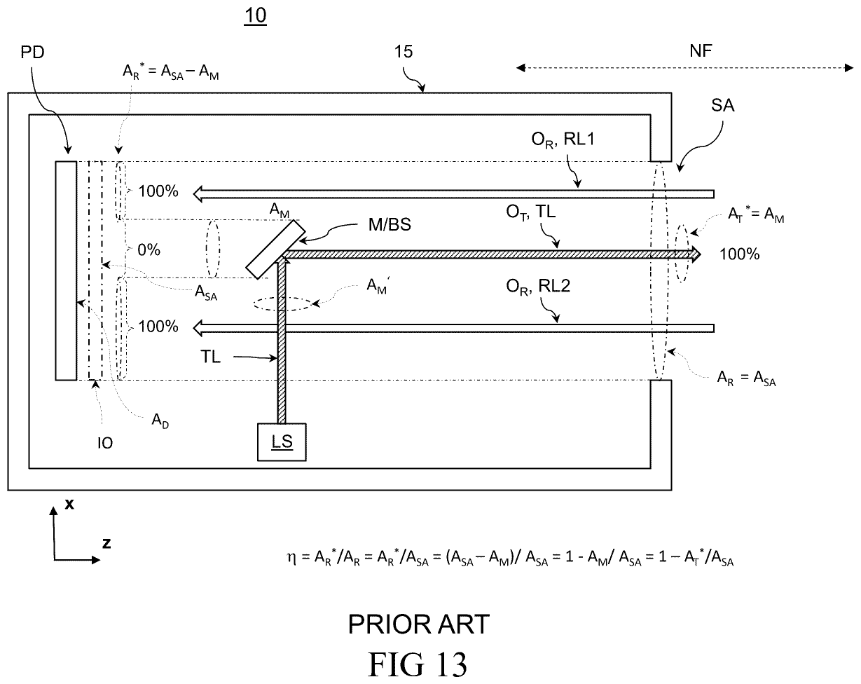

FIG. 13 shows an optical device 10 that may be used for outputting (emitting) an output light beam TL through an aperture SA of device 10 mainly provided for comparison with optical devices explained below. Aperture SA of device 10 may be provided by or arranged in (or next to) an opening of a device housing 15. A back-reflected light beam RL1, RL2 may be received through the aperture SA. Further, a power of beam RL1, RL2 may be detected using a light detector PD of device 10, e.g., a photodiode.

The exemplary light detector PD may include a SiPM (Silicon photomultipliers) which is a solid-state single-photon-sensitive device built from an array of avalanche photodiode (APD), single photon avalanche diode (SPAD), serving as detection elements on a common silicon substrate. The PD may be any one of or a combination of an APD, SiPM, PIN diode, or any other photodetector.

The transmitting part Or of the optical path of device 10 is folded in using a mirror M arranged between light source LS and aperture SA. As light detector PD is arranged behind mirror M in the receiving part OR of the optical path, a portion of the back-reflected light beam is obstructed, and thus 0% of this portion of the back-reflected light beam is received by the light sensitive detector PC. Only the two parts RL1, RL2 of the back-reflected light beam which reach the detector PD (at 100%, or at least at substantially 100%) are shown, while the central part received by mirror Mis omitted in FIG. 13 for clarity reasons. Mirror M may be a scanning mirror rotatable about the y-axis.

Accordingly, a receiving efficiency η may be defined as a ratio A_{R}*/A_{SA} between the effective area A_{R}*=A_{SA}−A_{M} of the receiving part OR of the optical path O between mirror M and the light detector PD that is illuminated by a received back-reflected light beam RL1, RL2, and an area A_{SA} of the back-reflected light beam at the aperture SA (which may be equal to the light sensitive area A_{R} of detector PD, A_{SA}=A_{R}).

Note that the illustrated detector PD is typically not to scale. In particular, the actual light detection area A_{D} of the detector PD may be (much) smaller (A_{D}<A_{SA}) due to a typically provided imaging optics IO used to focus the back-reflected light beam RL1, RL2 onto the detector PD. The detection area A_{D} may be smaller than the effective area A_{R}*, the area A_{R} and/or the area A_{SA} by at least a factor of ten. Imaging optics IO may include at least one lens for focusing the back-reflected light beam RL1, RL2, in particular least one lens for focusing each of the partial back-reflected light beams RL1, RL2.

This also applies to the light detectors of the other devices explained herein which may also use a respective imaging optics to focus received light beams onto the detector. However, an imaging optics, which may be provided in the receiving part of the optical path and/or may be arranged between the respective beam profile redistributor and (the collection area A_{D} of) the detector PD, is not shown for clarity reasons in most figures.

At the illustrated typical 45° orientation of mirror M with respect to the light sensitive surface of light detector PD, the aperture SA, the incident light beam TL received from light source LS and the back-reflected light beam RL1, RL2, respectively, the areas (projections of mirror M) A_{M}, A_{M} have the same size (0.707 of the mirror size).

As a result of the occlusion by mirror M, the receiving efficiency η can be calculated to be η=1−A_{T}*/A_{SA} with A_{T}* also representing the effective emission area of the device and the output light beam TL (in the near field NF), respectively. Expanding a transmission beam would require expanding the transmitting aperture accordingly. This transmitting aperture may be expanded, for example, by using a larger mirror M with a larger A_{M}. This may be desired, for example, to improve the eye-safety of the system. However, increasing A_{M} decreases the efficiency η of the system.

If mirror M is replaced by a polarization beam splitter of equal size that acts as a mirror for a given polarization and is transparent for transverse wave with same wavelength but orthogonal polarization that may be present in back-reflected light beam RL1, RL2, the receiving efficiency η can be calculated to be η=1−A_{T}*/(2*A_{SA}). For example, light beam TL may be linearly polarized. Compared to using the mirror, the receiving efficiency η is increased, because 50% of the central part of the back-reflected light beam received by polarization beam splitter (instead of mirror M) is transmitted through the polarization beam splitter and thus reaches the detector PD. The back-reflected light beam may be a back-scattered light beam having all polarization (50% of both orthogonal linear polarizations).

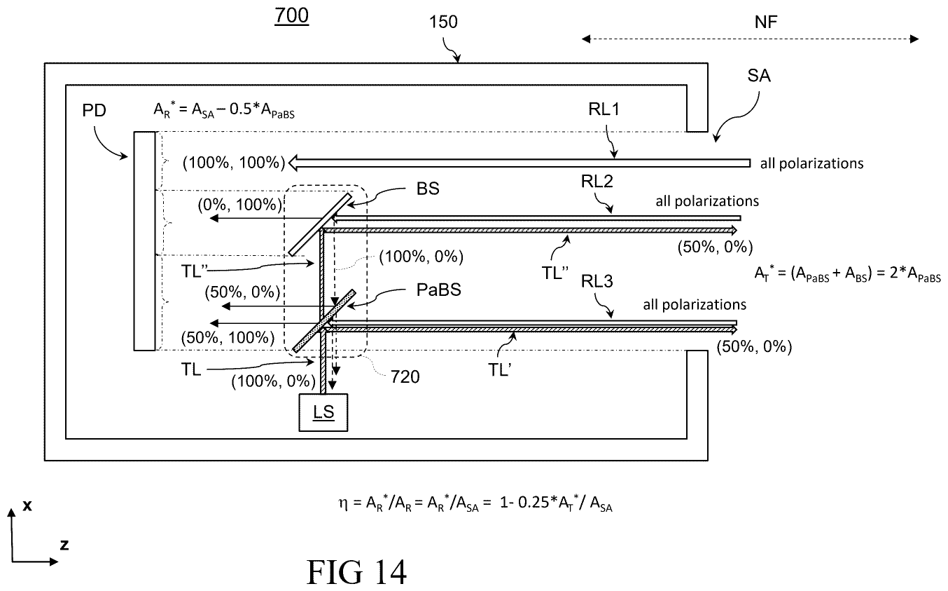

FIG. 14 shows a device 700 which is similar to device 10 but may be used for emitting an output light beam of two partial output beams TL′, TL″.

In the exemplary embodiment, it is assumed that light source LS produces a linearly polarized light beam TL as indicated by the bracket (100%, 0%). In the figures, brackets (P₁%, P₂%) represent the percentage of orthogonal first and second polarizations P₁, P₂ of the transverse waves of the light beams. However, this is not to be understood as limiting. The light beam TL may have any other defined polarization such as circular and elliptical polarization.

In the folded optical path of device 700, two beam splitters BS, PaBS of equal (optically active) size, equal (optically active) area and equal orientation (beam splitters BS, PaBS may also be parallel scanning optical elements) are arranged. The polarization beam splitter BS may act as (ideal) mirror for (transverse wave of) light beams of linear polarization P₁ and is transparent for (transverse wave of) light beams of linear polarization P₂. The partial (polarization) beam splitter PaBS is arranged in the optical path between light source LS and beam splitter BS. Partial (polarization) beam splitter PaBS is partially (50%) transparent and partially (50%) acts as beam splitter BS, i.e. is reflective for light of linear polarization P₁ and transparent for light of linear polarization P₂.

Accordingly, 50% of light beam TL is reflected by partial beam splitter PaBS as light beam TL′ towards device aperture SA, and 50% of light beam TL is transmitted as light beam TL″ to beam splitter BS where it is reflected towards device aperture SA. Thus, light beam TL is split by the two beam splitter PaBS, BS forming a beam profile redistributor 720 of device 700 into two partial output beams TL′, TL″ of equal power (50%) and polarization (P₁).

Assuming same size of the optical elements, the effective emission area A_{T}* corresponding to the sum of an area projection ABs of beam splitter BS and an area projection A_{PaBs} of partial beam splitter PaBS onto the device aperture SA (xy-plane) and the (light sensitive area) of the light detector, respectively, is doubled compared to device 10 explained above with regard to FIG. 13.

Doubling the effective emission area A_{T}* is achieved without reducing, compared to device 10 with mirror M of same size, the effective area A_{R}* of the receiving part. Similar as explained above for device 10, the effective area A_{R}* may be determined at or next to the beam profile redistributor formed by beam splitter BS and partial beam splitter PaBS, and/or between the beam profile redistributor BS, PaBS and light detector PD. For example, effective area A_{R}* may be determined between the beam profile redistributor BS, PaBS and a typically additionally provided imaging optics (not shown in FIG. 14) arranged in the receiving part or between the beam profile redistributor BS, PaBS (beam splitter BS and partial beam splitter PaBS) and the light detector PD.

Note that received back-scattered light RL2 of the second polarization P₂ is transmitted through beam splitter BS undeflected, that received back-scattered light RL2 of the first polarization P₁ is deflected to partial beam splitter PaBS at which 50% are deflected towards light detector PD, and that that 100% of the received back-scattered light RL3 of the first polarization P₁ and 50% of the received back-scattered light RL3 of the second polarization P₂ passes partial beam splitter PaBS undeflected and reach light detector PD. Thus, only 50% back-scattered light of the first polarization P₁ of received back-scattered light RL2, RL3 do not reach the detector PD.

As a result, the receiving efficiency η of optical device 700 can be calculated to be η=1−A_{T}*/(4*A_{SA}).

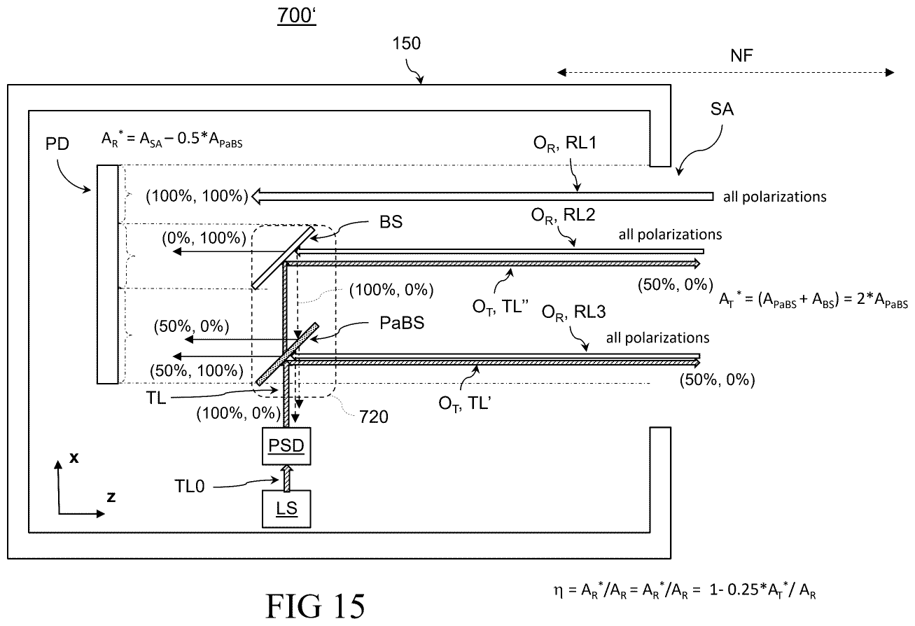

Device 700′ illustrated in FIG. 15 is similar to device 700 and may also be used in a LIDAR system. However, a polarization shaping device PSD such as a quarter wave plate is additionally arranged in the optical path between the light source LS and the partial beam splitter PaBS of device 700′ to convert a circularly polarized light beam TL0 of the light source into a linearly polarized light beam TL, or to convert a linear polarization of a laser light of light source LS into a circular polarization, when the second region(s) R2 of partial beam splitter PaBS are configured for circular polarization as second polarization.

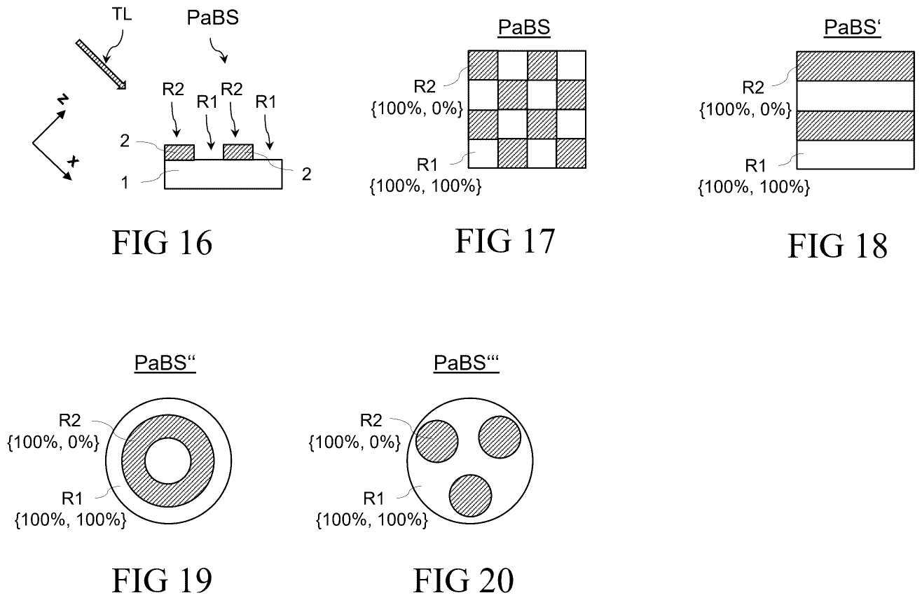

FIG. 16 to FIG. 20 illustrate schematic representations of example one-piece partial beam splitters that may be used in the optical devices described herein.

FIG. 16 is a schematic a side view of one-piece partial beam splitter PaBS that may be e.g. used in optical devices 700, 700′ as partial beam splitter for an incident light beam TL received from a light source. Accordingly, the optically active area(s) of partial beam splitter PaBS is formed by one or more first regions R1, and one or more second regions R2. One or more first regions R1 forms 50% of the optically active area of the partial beam splitter PaBS. Additionally, one or more first regions R1 is (are) at least substantially transparent for the incident light beam TL of given wavelength or wavelength range irrespective of the polarization. The remaining 50% of the optically active area(s) of partial beam splitter PaBS are formed by one or more second regions R2 (shown as filled regions). One or more second regions R2 is (are) at least substantially transparent for first transverses waves of the incident light beam TL having a first polarization P₁ and at least substantially reflective for the second transverse wave of the incident light beam TL. The incident light beam may have a second polarization P₂ different to the first polarization P₁.

Accordingly, partial beam splitter PaBS comprises as higher overall first transmittance for light of the first polarization (ideally 1 or 100%) compared to the second transmittance for light of the second polarization (0.5 or 50%) as indicated by the values in the curly brackets { } in FIGS. 17-20.

In top view, the first and second regions R1, R2 may be arranged with a chessboard pattern, having square, alternating segments as illustrated in FIG. 17 or in strips as illustrated in FIG. 18 showing a similar partial beam splitter PaBS′.

However, while a regular or periodic arrangement of the first and second regions R1, R2 may be preferred, the geometric shapes of the first and second regions R1, R2 may be different.

For example, the first and second regions R1, R2 may have polygonal shapes, or may also be circular, elliptic, or ring-shaped as illustrated in the top views of FIGS. 19, 20 for the partial beam splitters PaBS “, PaBS”.

For compliance with eye safety standards, the maximum diameter or average diameter of a first or second region may be below a threshold value. For example, a maximum diameter of the first regions R1 and the second region R2 is typically smaller than 7 mm.

As far as the structure is concerned, the typically substantially plate shaped or wafer shaped one-piece partial beam splitters PaBS−PaBS′″ may consist of a transparent carrier 1, e.g. a glass carrier, and a structured layer 2 arranged on carrier 1.

The structured layer 2 may be a multilayer stack of dielectric materials with variable thicknesses and/or refraction indices. Further, a structured metallic layer may be formed on carrier 1.

As shown in FIG. 20, an area ratio between a total area of the first region(s) R1 and a total area of the second region(s) R2 may also be larger than 1 to increase the second transmittance of the one-piece partial beam splitter PaBS′″ to a higher value, for example to ⅔ (0.67).

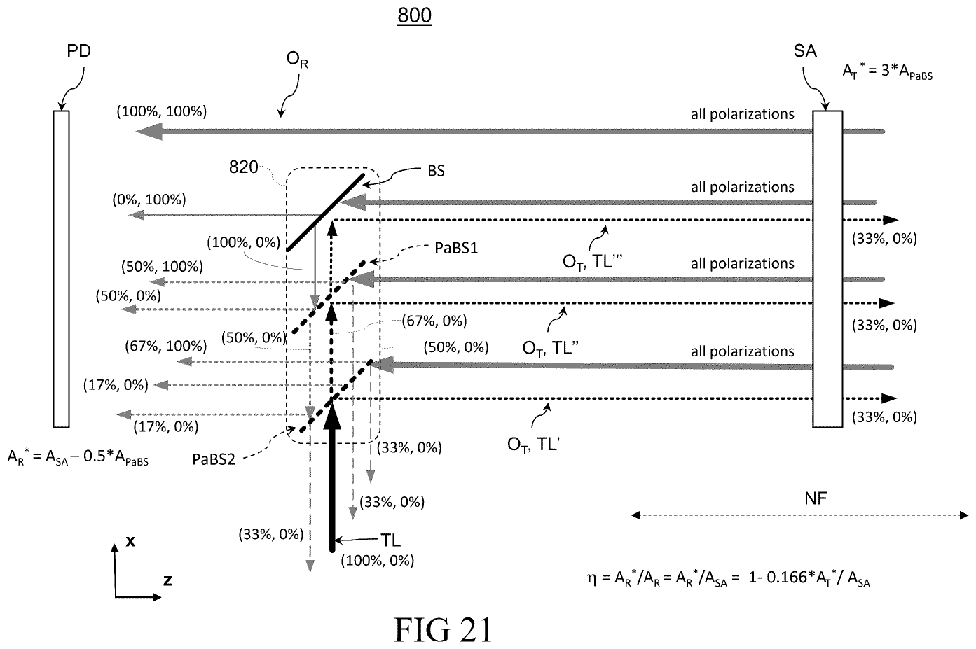

Such a partial beam splitter PaBS′″ may be used as first beam splitter of a beam profile redistributor 820 in a device 800 illustrated in FIG. 21. Except for the beam profile redistributor 820, device 800 is typically similar to the devices 700, 700′ but has a larger the effective emission area A_{T}* (emitted light beam perimeter) compared to the devices 700, 700′. For sake of clarity, the housing of device 800 is not shown.

In the exemplary embodiment, beam profile redistributor 820 has equally sized and oriented beam splitters BS, PaBS1, PaBS2 which are arranged in the optical path, namely a polarization beam splitter BS acting as (ideal) mirror for light of linear polarization P₁ and is transparent for light of linear polarization P₂, and two different partial (polarization) beam splitters PaBS1, PaBS2 arranged in the optical path between light source LS and beam splitter BS.

Partial (polarization) beam splitter PaBS1 is arranged between beam splitter BS and beam splitter PaBS2, and is partially (50%) transparent and partially (50%) acts as the beam splitter BS, i.e. is reflective for light of linear polarization P₁ and transparent for light of linear polarization P₂.

Partial (polarization) beam splitter PaBS2 is arranged between partial beam splitter PaBS1 and light source LS, and is partially (66.7%) transparent and partially (33.3%) acts as the beam splitter BS, i.e. is reflective for light of linear polarization P₁ and transparent for light of linear polarization P₂. In this example, the percent area of first regions R1 in PaBS2 is 66.7% of the total optically active area of PaBS2, and the percent area of second regions R2 in PaBS2 is 33.3% of the total optically active area of PaBS2.

Accordingly, the effective emission area A_{T}* of device 800 is tripled compared to device 10 explained above with regard to FIG. 13, due to using three equally sized beam splitters in series, given by the sum of an area projection ABs of beam splitter BS and the area projections A_{PaBs} of partial beam splitters PaBS1, PaBS2 onto the device aperture SA (xy-plane). Although the effective emission area is increased, the effective area A_{R}* of the receiving part OR of the optical path OT, OR is not reduced, and does not reduce the light power detectable by detector PD.

As a result, the receiving efficiency η of optical device 800 can be calculated to be η=1−A_{T}*/(6*A_{SA}).

The receiving efficiency η as function of the effective emission area A_{T}* may be further increased if more partial beam splitters are used, however to an increasingly lesser extent as the number of partial beam splitters increases. Further, not completely avoidable losses within the beam profile redistributor as well as costs and/or adjustment effort may become more relevant if a larger numbers of beam splitters is used.

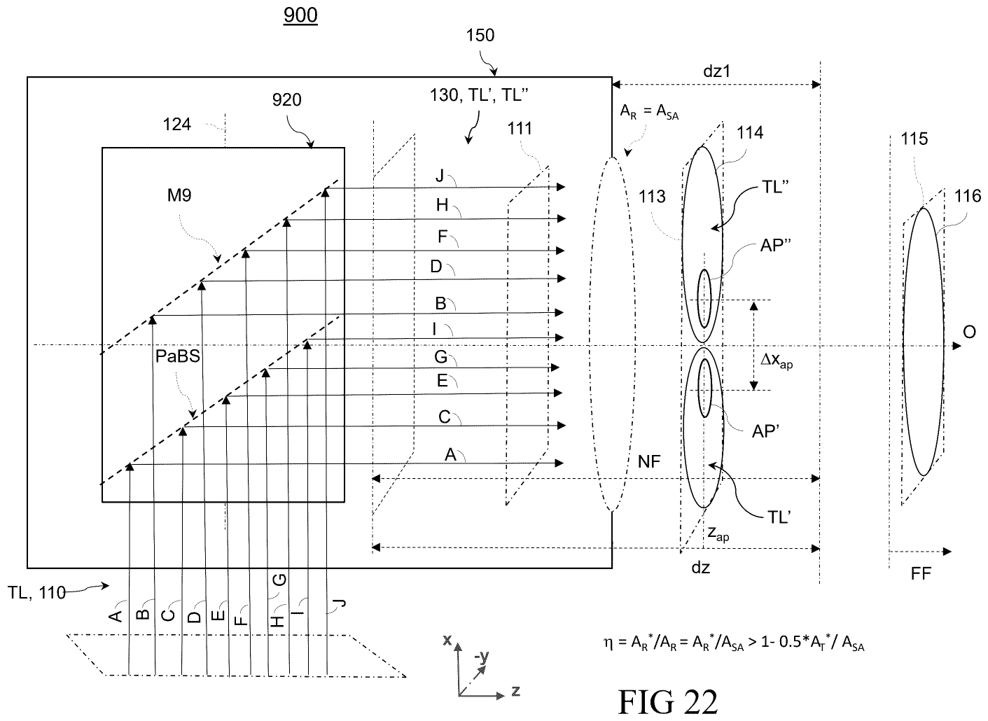

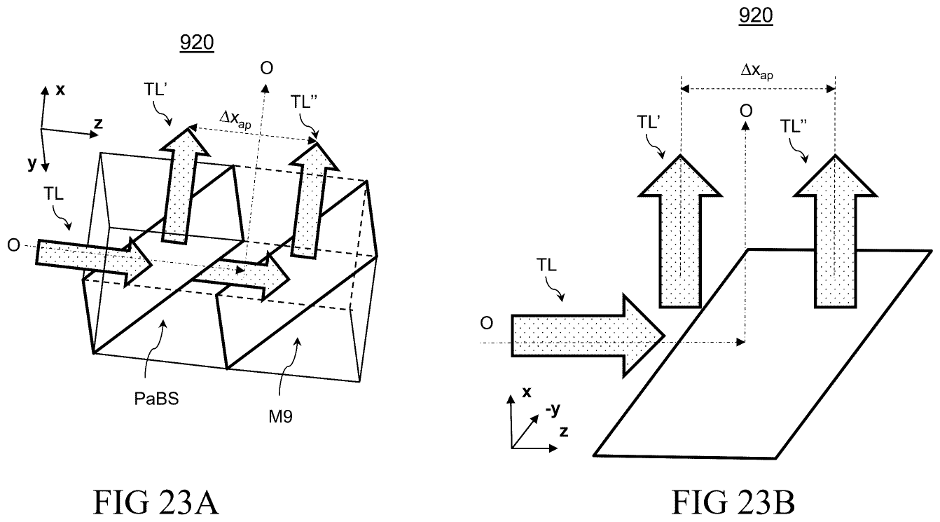

FIG. 22 shows a device 900 including a (one-piece) beam profile redistributor 920 with integrated partial beam splitter PaBS that is shown in a perspective view in FIG. 23A and a schematic view in FIG. 23B illustrating that partial beam splitter 920 is typically a one-piece optical element.

Device 900 is typically similar to the devices 100-800 explained above, in particular similar to devices 700, 700′ at least insofar as device 900 is also configured to emit an output light beam 130 formed, in the near field NF, by two partial output beams TL′, TL″, while the beam profile in the far field FF is substantially the same compared to a similar device in which the beam profile redistributor 920 is replaced by a simple mirror.

Further, the light rays A-K may be reordered by partial beam splitter 920, typically similar as explained above with regard to FIGS. 2 to 8.

In the exemplary embodiment, beam profile redistributor 920 is formed as a glass prism (such as a cuboid) with two internal (functional) surfaces acting as partial beam splitter PaBS as explained above and as a mirror M9, respectively.

Alternatively, beam profile redistributor 920 may be implemented as a prism with functional surfaces that act as partial beam splitter PaBS and as polarization beam splitter (BS instead of M9) acting as (ideal) mirror for light beams of a first polarization and is transparent for light beams of a second polarization.

Beam profile redistributor 920 is typically completed to a cuboid with a transparent material to reduce reflections (losses) by ensuring the surface is 90 degrees to the direction of the beams to optimize the angle of incidence to reduce reflections.

While also separate partial beam splitter PaBS and mirror M9 may be used, integrating both into a one-piece (glass) body may reduce alignment effort in the optical device. Further, a one piece beam profile redistributor will typically better ensure uniform size, and alignment of the optically active surfaces.

The distance between two parallel orientated internal surfaces acting as PaBS and mirror M9, respectively, determines the spot separation Δxₐₚ between the partial output beams TL′, TL″ in NF.

Each of the partial output beams TL′, TL″ fulfills the eye safety requirements as indicated by the exemplary measuring apertures AP′, AP″.

Also, for device 900 it can be shown that the receiving efficiency η is larger than 1−0.5*A_{T}*/A_{SA}. Receiving efficiency η=1−0.25*A_{T}*/A_{SA} may be achieved with a single PaBS. Receiving efficiency η=1−0.166*A_{T}*/A_{SA} may be achieved with multiple Partial beam splitters.

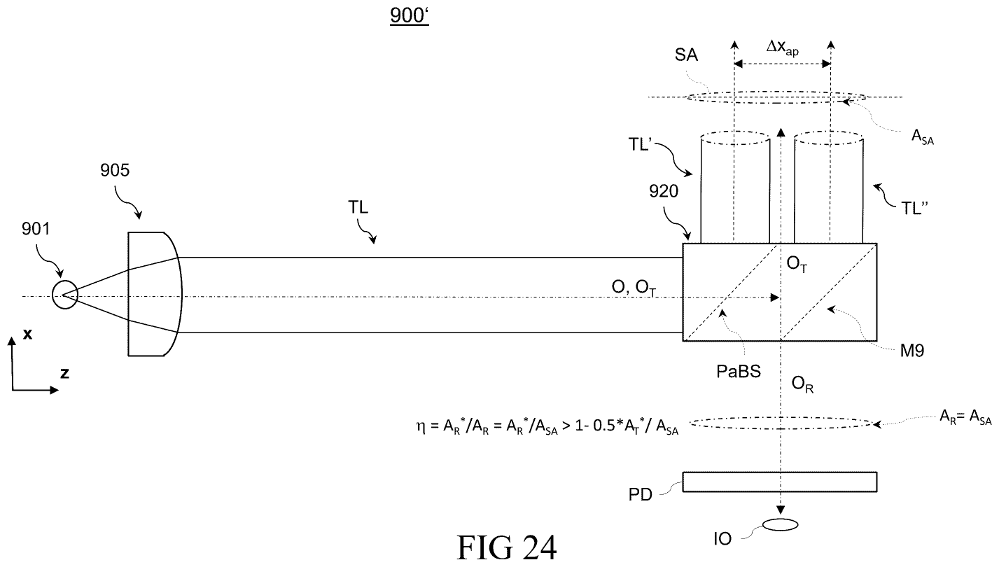

This is also illustrated in FIG. 24 showing a similar device 900′ with an optical path O which extends from a light source 901 emitting a light beam TL of a defined polarization, through a collimator 905 and a beam profile redistributor 920 with integrated partial beam splitter as explained above with regard to FIGS. 22-23B. Partial beam splitter is arranged in a transmitting part Or of optical path O which is folded due to partial beam splitter 920, and to a device aperture SA with device aperture area A_{SA}. A reflected (back-scattered light beam—not shown) may be received through device aperture SA, transmitted through beam profile redistributor 920, focused via an imaging optics IO arranged in a receiving part OR of optical path O onto a light detector PD which is arranged at the end of receiving part OR of optical path O. Light detector PD may have a light sensitive surface of lower size compared to an area A_{R} of the receiving part OR between the beam profile redistributor 920 and the imaging optics IO.

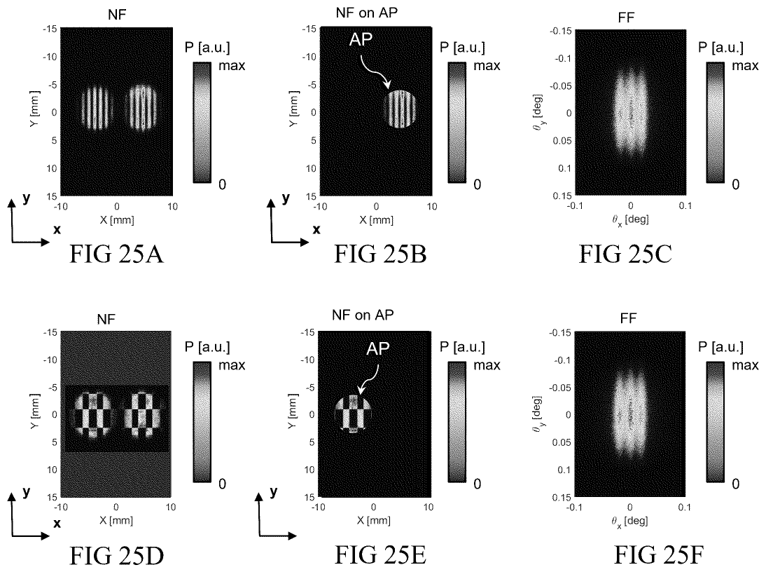

FIGS. 25A to 25F illustrate beam intensity profiles of light beams that may be generated using one of the devices 700, 700′ as illustrated in FIG. 14 and FIG. 15, respectively. Each figure corresponds to a density plot and is provided with a linear intensity/power scale.

In the exemplary embodiment, beam intensity profiles shown in FIGS. 25A-25C and FIG. 25D-25F correspond to beam intensity profiles (radiant flux/power P in radial planes perpendicular to axis O) of output light beam of a device 700, 700′ with a beam profile redistributor consisting of a partial beam splitter and a polarization beam splitter (BS). However, FIGS. 25A-25C correspond to a beam profile redistributor with a partial beam splitter PaBS' as illustrated in FIG. 18, while FIGS. 25D-25F correspond to a beam profile redistributor with a partial beam splitter PaBS as illustrated in FIG. 17, and correspond to emission of a beam with a beam intensity profile illustrated in FIGS. 3A, 3B, 3C.

While the beam properties in the far field FF (FIGS. 25C, 25F) are not substantially changed compared to device 10 shown in FIG. 13 (with a mirror instead of the beam profile redistributor, data not shown), the integral power at (7 mm) measuring apertures in the near field NF is reduced even for the illustrated measuring apertures AP of highest integral power (FIGS. 25B, 25E).

In summary, a better trade-off between the effective emission area and the receiving efficiency is achieved and eye-safety requirements in NF are met without affecting the FF properties of the emitted light beam.

According to an embodiment of an optical device, in particular a scanning optical device and/or a lidar device, the device includes an optical path and beam profile redistributor arranged in the optical path, configured to split a received incident light beam into at least two output light beams. The optical device includes a partial beam splitter having a first transmittance for light waves of the incident light beam. The incident light beam has a first polarization and a first wavelength or is within a first wavelength range, in particular from the IR-range. The partial beam splitter has a second transmittance for waves of the incident light beam with a second polarization different to the first polarization and a second wavelength at least substantially matching the first wavelength (e.g., at the first wavelength) or at least substantially being within the first wavelength range, the second transmittance being larger than zero and lower than the first transmittance.

The second transmittance is typically at least about 0.5.

Typically, the partial beam splitter further includes at least one of: a further partial beam splitter having a different second transmittance, a mirror, and a polarization beam splitter which is reflective for waves of the incident light beam with the first polarization and is transparent for waves of the incident light beam with the second polarization.

The partial beam splitter(s) may be implemented as respective one-piece partial beam splitter.

Alternatively or in addition, one partial beam splitter and a mirror may be implemented as a one-piece optical element.

Further, the optical device typically includes a light source and a device aperture, wherein the partial beam splitter is arranged between the light source and the device aperture.

Even further, the optical device typically includes a light detector for a reflected (back-scattered) light beam to be received through the device aperture and the beam profile redistributor.

According to an embodiment of an optical device, in particular a scanning optical device and/or a LIDAR device, the optical device includes an optical path, and a beam profile redistributor arranged in the optical path. The beam profile redistributor includes (provides), in a cross-section parallel to the optical path, a first pair of refractive surfaces ({120₁, 120₂}, {220₁, 220₂}, {420₁, 420₂}, {620₁, 620₂} in FIGS. 2, 7, 9, 12) which are adjacent to each other (typically directly adjacent/adjoining) at a first (internal) angle (α), and a second pair of refractive surfaces ({120₃, 120₄}, {220₃, 220₄}, {420₃, 420₄}, {620₃, 620₄} in FIGS. 2, 7, 9, 12) which are adjacent to each other (typically directly adjacent/adjoining) at a second (internal) angle (B) which typically at least substantially matches the first angle (α). The cross-section may be a central cross-section and/or include the optical path (at least at and/or in the beam profile redistributor).

This allows for reliably lowering the output light power of an output light beam of the device when measured using a measuring aperture (flux through the aperture) at a or even any position along the optical path in the near field without substantially changing the beam intensity profile of the output light beam in the far field in a comparatively simple and compact manner.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Such modifications to the inventive concept are intended to be covered by the appended claims.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise. Further, terms such as “first”, “second”, and the like, are also used to describe various elements, regions, sections, etc. and are also not intended to be limiting. Like terms refer to like elements throughout the description.

With the above range of variations and applications in mind, it should be understood that the present invention is not limited by the foregoing description, nor is it limited by the accompanying drawings. Instead, the present invention is limited only by the following claims and their legal equivalents.

### Terms and Definitions

### Optical System

Disclosed embodiments may involve an optical system. As used herein, the terms “optical system” or “optical device” include any system or device that is used for the generation, detection and/or manipulation of light. By way of example only, an optical system may include one or more optical components for generating, detecting and/or manipulating light. For example, light sources, lenses, mirrors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

### LIDAR System

Consistent with the present disclosure, the optical system may include a LIDAR system or may be included as a portion of a LIDAR system. As used herein, the terms “LIDAR system” or “LIDAR device” include any system or device which can determine values of parameters indicative of a distance between a pair of tangible objects based on reflected light. In one embodiment, the LIDAR system may determine a distance between a pair of tangible objects based on reflections of light emitted by the LIDAR system. As used herein, the term “determine distances” includes generating outputs which are indicative of distances between pairs of tangible objects. The determined distances may represent physical dimensions between a pair of tangible objects. By way of example only, the determined distances may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g. number of meters, number of inches, number of kilometers, number of millimeters), a number of arbitrary length units (e.g. number of LIDAR system lengths), a ratio between the distance to another length (e.g. a ratio to a length of an object detected in a field of view of the LIDAR system), an amount of time (e.g. given as standard unit, arbitrary units or ratio, for example, the time it takes light to travel between the tangible objects), one or more locations (e.g. specified using an agreed coordinate system, specified in relation to a known location), and more.

### Time of Flight

The LIDAR system may determine the distance between a pair of tangible objects based on reflected light. In one example, the LIDAR system processes detection results of a sensor which creates temporal information indicative of a period of time between the emission of a light signal and the time of its detection by the sensor. The period of time may be referred to as a “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal travelled between emission and detection. In another embodiment, the LIDAR system may determine the distance based on frequency phase-shift (or multiple frequency phase-shift). Specifically, the LIDAR system may process information indicative of one or more modulation phase shifts (e.g., by solving some simultaneous equations to give a final measure) of the light signal. For example, the emitted optical signal may be modulated with one or more constant frequencies. The at least one phase shift of the modulation between the emitted signal and the detected reflection may be indicative of the distance the light travelled between emission and detection. The modulation may be applied to a continuous wave light signal, to a quasi-continuous wave light signal, or to another type of emitted light signal. It is noted that additional information may be used by the LIDAR system for determining the distance, e.g., location information (e.g., relative positions) between the projection location, the detection location of the signal (especially if distanced from one another), and more.

### Detecting an Object

In some embodiments, the LIDAR system may be used for detecting a plurality of objects in an environment of the LIDAR system. The term “detecting an object in an environment of the LIDAR system” includes generating information which is indicative of an object that reflected light toward a detector associated with the LIDAR system. If more than one object is detected by the LIDAR system, the generated information pertaining to different objects may be interconnected, for example a car is driving on a road, a bird is sitting on a tree, a man touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25 m, 50 m, etc.). In another example, the LIDAR system may be used for detecting a plurality of objects in an environment of a vehicle or within a predefined horizontal range (e.g., 25°, 50°, 100°, 180°, etc.), and up to a predefined vertical elevation (e.g., +10°, +20°, +40°-20°, +90° or) 0°-90°.

As used herein, the term “detecting an object” may refer to determining an existence of the object (e.g., an object may exist in a certain direction with respect to the LIDAR system and/or to another reference location, or an object may exist in a certain spatial volume). Additionally, or alternatively, the term “detecting an object” may refer to determining a distance between the object and another location (e.g. a location of the LIDAR system, a location on earth, or a location of another object). Additionally or alternatively, the term “detecting an object” may refer to identifying the object (e.g. classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally, or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°×0.1° or 0.3°×0.3° of the field of view.

### Object

Consistent with the present disclosure, the term “object” includes a finite composition of matter that may reflect light from at least a portion thereof. For example, an object may be at least partially solid (e.g. cars, trees); at least partially liquid (e.g. puddles on the road, rain); at least partly gaseous (e.g. fumes, clouds); made from a multitude of distinct particles (e.g. sand storm, fog, spray); and may be of one or more scales of magnitude, such as ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g. laser beam projected onto a road or a building); in other cases, the object may be partly blocked by another object between the LIDAR system and the detected object; in other cases, the LIDAR's sensor may only detect light reflected from a portion of the object, e.g., because ambient light or other interferences interfere with detection of some portions of the object.

### FOV

As used herein the term “field of view of the LIDAR system” may include an extent of the observable environment of the LIDAR system in which objects may be detected. It is noted that the field of view (FOV) of the LIDAR system may be affected by various conditions such as but not limited to: an orientation of the LIDAR system (e.g. is the direction of an optical axis of the LIDAR system); a position of the LIDAR system with respect to the environment (e.g. distance above ground and adjacent topography and obstacles); operational parameters of the LIDAR system (e.g. emission power, computational settings, defined angles of operation), etc. The field of view of LIDAR system may be defined, for example, by a solid angle (e.g., defined using ϕ, θ angles, in which ϕ and θ are angles defined in perpendicular planes, e.g. with respect to symmetry axes of the LIDAR system and/or its FOV). In one example, the field of view may also be defined within a certain range (e.g., up to 200 m).

The term “instantaneous field of view” may include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, the LIDAR system may be configured to scan scene in the environment in which the LIDAR system is operating. As used herein the term “scene” may include some or all of the objects within the field of view of the LIDAR system, in their relative positions and in their current states, within an operational duration of the LIDAR system. For example, the scene may include ground elements (e.g., earth, roads, grass, sidewalks, road surface marking), sky, man-made objects (e.g., vehicles, buildings, signs), vegetation, people, animals, light projecting elements (e.g. flashlights, sun, other LIDAR systems), and so on.

### Light Source

Consistent with disclosed embodiments, the LIDAR system may include at least one projecting unit with a light source configured to project light. As used herein the term “light source” refers to any device configured to emit light. In one embodiment, the light source may be a laser such as a solid-state laser, laser diode, a high-power laser, or an alternative light source such as, a fiber laser and a light emitting diode (LED)-based light source. In addition, light source 112 as illustrated throughout the figures, may emit light in differing formats, such as light pulses, continuous wave (CW), quasi-CW, and so on. For example, one type of light source that may be used is a semiconductor laser, such as a vertical-cavity surface-emitting laser (VCSEL) or an edge-emitting laser. Another type of light source that may be used is an external cavity diode laser (ECDL). In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value.

### Sensor

Consistent with disclosed embodiments, the LIDAR system may include at least one sensing unit with at least one sensor configured to detect reflections from objects in the field of view. The terms “sensor”, “detector”, “sensing unit”, “detection unit”, “collection unit” include any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g. atmospheric temperature, rain, etc.).

In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 μm and about 50 μm, wherein each SPAD may have a recovery time of between about 20 ns and about 100 ns. Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system.

| List of reference signs | |
|---|---|
| α | angular span of light beam |
| α, β | angle between adjacent refractive surfaces |
| dz, dz1, Δxₐₚ | distance |
| x, y, z | Cartesian coordinates |
| A . . . K | light rays |
| AP | (virtual) aperture (opening) |
| BS | beam splitter |
| FF | far field |
| NF | near field |
| O | optical axis/central ray |
| P | beam power |
| PaBS-PaBS″′, PaBS1, PaBS2 | one-piece partial beam splitter |
| 100_{L}, 100, 100′, 200, 200′, 300, 400, 500, 600, | |
| 700, 700′, 800, 900, 900' | device for emitting a collimated light beam/ |
| | laser emitter (VCEL)/LIDAR (system) |
| 101, 101′, 201, 301, 401, 501, 601 | light source/laser |
| 102, 202, 402, 502, 602 | (divergent) light beam emitted from light source |
| 105, 205, 325, 405, 445, 505, 525, 605 | collimator |
| 110, 210, 302, 410, 610 | input light beam/first light beam/light beam to |
| | be converted |
| 111, 113, 115, 511, 513, 515 | (minimum) bounding box of output light beam |
| 114, 116, 512, 514, 516 | outer boundary of light beam |
| 120, 220, 320, 420, 520, 620 | beam profile redistributor |
| 121, 122, 421, 422, 621 | prism |
| 124 | (radial/symmetry) plane |
| 130, 230, 330, 430, 530, 630 | output light beam/second light beam/converted |
| | light beam |
| 150 | device housing |
| 151 | device (emitting/transmitting) aperture/optical |
| | outlet |
| 221, 222 | axicon |
| 312 | intermediate light beam |
| 425 | rotating polygon scanner |
| 535 | waist of output light beam |

1. A device, comprising:
an optical path; and
a beam profile redistributor arranged in the optical path to receive an input light beam, and configured to convert the received input light beam so that at least one output light beam of the device comprises:
in a near field and/or at the beam profile redistributor, a redistributed beam intensity profile compared to at least one further output light beam when the beam profile redistributor is not present;
within a given measuring aperture at a position along the optical path in the near field, a lower output light power compared to the at least one further output light beam; and
in a far field, at least substantially the same beam intensity profile compared to the at least one further output light beam.

2. The device according to claim 1, wherein the at least one output light beam comprises, in the near field and in a bounding box for the at least one output light beam, at least substantially the same boundary compared to the at least one further output light beam.

3. The device according to claim 2, wherein the bounding box is situated at a position with respect to the optical path where the at least one output light beam has a waist.

4. The device according to claim 1, wherein the beam profile redistributor comprises at least one element selected from the group of elements consisting of: a prism, a lens such as an aspherical lens, a top-hat converter, a diffractive optical element such as a grating, a phase shifter, a meta surface optionally comprising nano-antennas, a liquid crystal display, a liquid crystal on silicon, a reflector such as a digital micromirror device, and a set of reflectors such as at least two mirrors, such as a micromirror array.

5. The device according to claim 1, wherein the beam profile redistributor comprises at least one prism selected from the group of prisms consisting of: a right trigonal prism and a right hexagonal prism.

6. The device according to claim 1, wherein the beam profile redistributor comprises, in a cross-section parallel to the optical path, pairs of refractive surfaces, each pair comprising two refractive surfaces that are adjacent to each other.

7. The device according to claim 1, wherein the beam profile redistributor comprises at least one pair of prisms.

8. The device according to claim 7, wherein the prisms of the pair of prisms are at least substantially centered with respect to each other and/or with respect to the optical path, are at least substantially equally shaped, are arranged at least substantially mirror symmetric with respect to the optical path and/or a plane at least substantially perpendicular to the optical path, and/or comprise respective base surfaces that are parallel to each other and/or are facing away from each other.

9. The device according to claim 7, wherein the beam profile redistributor comprises two pairs of prisms such as two pairs of prisms that are rotated with respect to each other and/or with respect to the optical path.

10. The device according to claim 1, wherein the beam profile redistributor is configured to change an order of light rays in the at least one output light beam, compared to the at least one further output light beam, without substantially changing a light beam boundary and/or without substantially changing a light beam divergence.

11. The device according to claim 1, wherein the beam profile redistributor is configured to invert the input light beam along at least one axis, such that a light ray of the input light beam that is near an edge of the input light beam is redirected to a corresponding light ray of the at least one output light beam that is near a center line of the at least one output light beam, and a light ray of the input light beam that is near a center line of the input light beam is redirected to a corresponding light ray of the at least one output light beam that is near an edge of the at least one output light beam.

12. The device according to claim 11, wherein the closer the light ray of the input light beam is to the center line of the input light beam, the closer the corresponding light ray of the at least one output light beam is to the edge of the at least one output light beam, and wherein the closer the light ray of the input light beam is to the edge of the input light beam, the closer the corresponding light ray of the at least one output light beam is to the center line of the at least one output light beam.

13. The device according to claim 1, further comprising:
a light source configured to emit the input light beam; and
a collimator arranged in the optical path,
wherein the beam profile redistributor is arranged in the optical path between the light source and the collimator.

14. The device according to claim 1, wherein the beam profile redistributor is arranged in the optical path to receive a divergent input light beam and is configured to:
transmit a divergent intermediate light beam comprising at least substantially the same angular span as the received divergent input light beam, and
convert a light ray of the input light beam, which comprises an incident angle, into a light ray of the intermediate light beam, such that the light ray of the intermediate light beam comprises an exit angle different from the incident angle, wherein the lower an absolute value of the incident angle is, the higher an absolute value of the exit angle is, and/or wherein the higher an absolute value of the incident angle is, the lower an absolute value of the exit angle is.

15. The device according to claim 1,
wherein the given measuring aperture is defined by a safety standard such as a Class 1 laser standard, and
wherein the device meets the safety standard.

16. The device according to claim 15, wherein, per the safety standard, the given measuring aperture comprises an at least substantially circular or elliptical shape or an at least substantially square/rectangular shape, such as a circular shape of about 5 mm to about 15 mm diameter, such as of about 6 mm to about 9 mm diameter, such as of about 7 mm diameter, or a square shape of about 5 mm to about 11 mm base length, such as of about 5 mm to about 9 mm base length, such as about 7 mm base length, and/or wherein an area of the given measuring aperture is in a range from about 9 mm² to about 121 mm², such as from about 25 mm² to about 81 mm², such as from about 35 mm² to about 50 mm², for example about 38 mm² or about 49 mm².

17. The device according to claim 1, further comprising an optical outlet, wherein the beam profile redistributor is configured such that the redistributed beam intensity profile is at least substantially maintained up to a distance of at least 1 m, such as at least 3 m or at least 5 m, from the beam profile redistributor and/or the optical outlet of the device.

18. The device according to claim 1, wherein the device further comprises an optical outlet, and wherein the far field begins at a distance of at least 10 m, such as at least 20 m, from the beam profile redistributor and/or the optical outlet of the device.

19. The device according to claim 1, wherein the device is a scanning device such as a LIDAR device or a component thereof.

20. A LIDAR device, comprising:
an optical path; and
a beam profile redistributor arranged in the optical path to receive an input light beam and configured to convert the received input light beam into at least one output light beam, wherein, in a cross-section parallel to the optical path, the beam profile redistributor comprises:
a first pair of adjacent refractive surfaces arranged at a first angle with respect to each other; and
a second pair of adjacent refractive surfaces arranged at a second angle with respect to each other,
the first pair of adjacent refractive surfaces being arranged between the input light beam and the second pair of adjacent refractive surfaces, and
the second pair of adjacent refractive surfaces being arranged between the first pair of adjacent refractive surfaces and the at least one output light beam.
